(19) United States
(12) Patent Application Publication
(10) Pub. No.: US 2010/0153151 A1
(43) Pub. Date: Jun. 17, 2010

(54) Method and Apparatus for Determining Applicable Permits and Permitting Agencies for a Construction Project

(76) Inventor: Leonard Peter Toenjes, St. Louis, MO (US)

Correspondence Address: THOMPSON COBURN LLP, ONE US BANK PLAZA, SUITE 3500, ST LOUIS, MO, 63101, US

(21) Appl. No.: 12/336,299

(22) Filed: Dec. 16, 2008

(51) Int. Cl. G06Q 10/00; G06Q 50/00; G06F 3/048; G06F 7/00

(52) U.S. Cl. 705/7; 715/733

(57) ABSTRACT

Systems and methods for providing a computer-implemented interactive system for determining which permits are applicable to a construction project are disclosed. Also disclosed are techniques for reducing the number of questions that are asked to determine the applicable permits by selecting questions for presentation to the user based on a number of permits that are relevant to that question. Still further, disclosed are methods and systems for allowing a user to create the data structure used by the system to determine which permits are applicable to a construction project.

### FIELD OF THE INVENTION

The present invention relates to an internet-based interactive website that provides information about permits and permitting agencies that are applicable to a construction project.

### BACKGROUND AND SUMMARY OF THE INVENTION

Various state, local, and federal laws and rules often require a contractor (or other interested party) to obtain a multitude of permits relating to a construction project. Examples of different permits that may be applicable to a construction project include building permits, electrical permits, sewer permits, environmental permits, mechanical permits, elevator permits, land disturbance permits, etc. Determining a complete list of all the permits applicable to a given construction project can be a daunting, difficult and time-consuming task. For example, a construction project in one municipality in St. Louis County, Mo. may have a different set of applicable permitting agencies and permits than a similar construction project in a different municipality in that same county. For large metropolitan areas, in which there are many potentially applicable permits (issued from many different permitting agencies), contractors must become familiar with all of these permits (and permitting agencies) to be effective in their work. As a result of these various permit requirements, a single construction project could conceivably require 20 permits from 15 different permitting agencies.

Contractors must first be able to identify which permitting agencies have jurisdiction over the construction project, which can be a challenging task in and of itself. Second, after having properly determined which permitting agencies have jurisdictional authority over the construction project, the contractor must then be able to interpret and apply the different permitting agencies' often byzantine rules to identify which permits are applicable to the construction project. Errors, oversights, or delays in these determinations can not only complicate and add costs to a construction project, but they can also detract from a contractor's reputation with its customers.

While efforts have been made to automate the process of facilitating compliance with regulatory requirements for construction projects, for example as described in U.S. Patent Application Publications 2003/0101070, 2002/0129001, 2003/0217036, and U.S. Pat. No. 6,745,187, the entire disclosures of which are incorporated herein by reference, the inventors believe that these efforts leave room for a great degree of improvement with respect to automating permit applicability determinations for a number of reasons. As an example, the inventors herein are not aware of any tool that provides a single portal for quickly and efficiently determining all of the permit requirements applicable to a construction project.

Toward these ends, the inventors disclose a number of embodiments for a method and apparatus for automatically determining applicable permits and permitting agencies for a construction project based on user input which defines a construction project.

According to one aspect of an exemplary embodiment, disclosed herein is an apparatus for determining which of a plurality of permits are applicable to a construction project, the apparatus comprising: (i) a processor for communication over a network with a user computer, and (ii) a memory in communication with the processor, the memory comprising a data structure, the data structure comprising data corresponding to a plurality of permits and data corresponding to a plurality of applicability requirements for the permits, wherein the processor is configured to execute a software application, the software application being configured to interact with a user of the user computer through a plurality of graphical user interface (GUI) pages, the GUI pages being configured to (1) prompt the user for information about a construction project, and (2) accept information about the construction project from the user computer to thereby define the construction project, and wherein the software application is further configured to process the accepted construction project information against the data structure to determine all of the permits which are applicable to the defined construction project.

According to another aspect of an exemplary embodiment, disclosed herein is a method for determining which of a plurality of permits are applicable to a construction project, the method comprising: (i) interacting with a user of a user computer through a plurality of graphical user interface (GUI) pages, wherein the interacting step comprises (1) prompting the user for information about a construction project, and (2) accepting information about the construction project from the user computer to thereby define the construction project, and (ii) processing the accepted construction project information against a data structure to determine all of the permits which are applicable to the defined construction project, wherein the data structure comprises data corresponding to the plurality of permits and data corresponding to a plurality of applicability requirements for the permits, wherein the interacting and processing step are performed by at least one processor, and wherein the data structure is resident on a computer memory in communication with the at least one processor.

According to another exemplary embodiment, disclosed herein is an apparatus for determining which of a plurality of permits are applicable to a construction project, the apparatus comprising: (i) a processor for communication over a network with a user computer, the processor configured to execute a software application, the software application being configured to interact with a user of the user computer through a plurality of graphical user interface (GUI) pages, the GUI pages being configured to (1) prompt the user for information about a construction project, and (2) accept information about the construction project from the user computer to thereby define the construction project, and (ii) a memory in communication with the processor, the memory comprising a data structure, the data structure comprising (1) a plurality of data objects which are representative of the permits, (2) a plurality of data objects which are representative of prompts for information about the construction project, (3) a plurality of data objects which are representative of potential prompt responses for the prompts, and (4) a plurality of data objects which associate the prompt responses with the permits such that the software application can query the data structure based on the accepted construction project information to assess which permits can be confirmed as applicable or inapplicable to the defined construction project, wherein the software application is further configured to process the accepted construction project information against the data structure to determine which of the permits are applicable to the defined construction project.

According to still another exemplary embodiment, disclosed herein is a method for determining which of a plurality of permits are applicable to a construction project, the method comprising: (i) interacting with a user of the user computer through a plurality of graphical user interface (GUI) pages, wherein the interacting step comprises (1) prompting the user for information about a construction project, and (2) accepting information about the construction project from the user computer to thereby define the construction project, and (ii) processing the accepted construction project information against a data structure to determine which of the permits are applicable to the defined construction project, wherein the data structure comprises (1) a plurality of data objects which are representative of the permits, (2) a plurality of data objects which are representative of prompts for information about the construction project, (3) a plurality of data objects which are representative of potential prompt responses for the prompts, and (4) a plurality of data objects which associate the prompt responses with the permits such that the processing step can query the data structure based on the accepted construction project information to assess which permits can be confirmed as applicable or inapplicable to the defined construction project, wherein the interacting and processing step are performed by at least one processor, and wherein the data structure is resident on a computer memory in communication with the at least one processor.

Preferably, the processor also determines and identifies the appropriate permitting agencies where the applicable permits can be obtained. As used herein, a “permitting agency” refers to an entity, typically governmental, that has jurisdictional authority to approve or deny a permit relating to a construction project. Examples of different permitting agencies which have jurisdictional authority throughout or in parts of the St. Louis area include the City of Clayton, St. Louis County, the Metropolitan Sewer District (MSD), and the Missouri Department of Natural Resources. Also, as used herein, a permit is “applicable” if it is required for a construction project according to the rules/regulations of a permitting agency as those rules/regulations are modeled in a data structure, and “inapplicable” otherwise. While it can be expected that some permits may be deemed “optional” if its applicability requirements are met, in an exemplary embodiment, the software will still determine the applicability for such permits and report their optional applicability to a user. In such an instance, it is preferred that the report also identify the optional nature of the permit. A permit that has been “confirmed” is a permit that the system has determined is either applicable or inapplicable to the defined construction project. A permit is “unconfirmed” if the system has not yet determined whether it is applicable or inapplicable to the defined construction project.

In a preferred embodiment, the processor takes the form of a server which hosts a website. As the user interacts with the website, the website provides the user with prompts for information about the construction project (e.g., questions about the construction project), and the user in turn provides responses to those prompts to thereby to provide the website with information that describes the nature of the construction project. Software logic within the website determines which potential permits and permitting agencies are “confirmed” and “unconfirmed” in response to the user input and iteratively repeats the prompting and prompt response process until all permits have been confirmed as either applicable or inapplicable to the defined construction project. To support this processing, the memory preferably stores a data structure that associates different permits with the prompts for information and the potential responses to such prompts to thereby support functionality for exemplary embodiments with respect to determining which permits are applicable to the defined construction project.

According to another aspect of an exemplary embodiment of the present invention, the memory takes the form of a database, preferably a relational database, that stores permit information in one or more database tables. For example, the database may store information about (1) the permits covered by the website, (2) the permitting agencies for those permits, (3) the construction project as defined by user input, (4) prompts for prompting the user for input about the construction project, and (5) the set of options for a user to respond to the prompts. Database associations between such information preferably defines the logic for determining which permits are applicable to a defined construction project. The database may also include a table for storing associations between permits and permitting agencies.

In a preferred embodiment, the data structure is configured to improve the efficiency of the interactive permit applicability determination process in instances where the website is configured to determine the applicability of multiple permits to a construction project. By configuring the data structure to associate permits with predefined prompt responses such that a software application can apply a construction project (as defined by a user's prompt responses from among the set of predefined prompt response options) to the data structure to determine the applicable permits, the data structure avoids the need for a user to repetitively respond to what would essentially be duplicative prompts. For example, suppose Sewer Permit X can be confirmed as applicable if a construction project will have 25 flush toilets or more and Plumbing Permit Y can be confirmed as inapplicable if a construction project has fewer than 25 flush toilets. By associating the prompt “How Many Flush Toilets Will Be Installed?” with the prompt response options “≧25” and “<25”, and by associating the “≧25” prompt response with an applicability data object for Sewer Permit X and by associating the “<25” prompt response with an inapplicability data object for Plumbing Permit Y, the data structure allows the software application to resolve the applicability of both Sewer Permit X and Plumbing Permit Y by way of the user's response to a single prompt. However, a naive system would require that the user progress through a separate set of prompts for each of the different permits, thereby resulting in the need for the user to respond to essentially redundant prompts.

Further still, in a preferred embodiment, the data structure and software application are configured to further increase the efficiency of the interactive permit applicability determination process by selecting prompts from the data structure for presentation to the user based on which prompt has a greatest weight toward resolving the applicability of the most permits. The scoring of prompts to assess which has the greatest weight can be performed in a number of ways. For example, the software can dynamically query the data structure to determine which unpresented prompts have the greatest number of permits associated with them. As another example, the data structure can store a data object in association with each prompt that identifies how many permits can be confirmed as applicable or inapplicable based on that prompt's response options. Then, when selecting which prompt should be presented to the user, the software application can use these data objects as the measure of the prompts' weights. Optionally, the software application can dynamically update the data structure as prompt responses are received (and as various permits are confirmed as applicable or inapplicable) to decrement the weighting data objects. For example, if Prompt Q is initially relevant to resolving the applicability of Permits 1, 2, and 5, its initial weighting data object would have a value of 3. Should previous user input result in a conclusion that Permit 1 is inapplicable, then Prompt Q's weighting data object can be dynamically updated to a new value of 2.

According to another aspect of an exemplary embodiment of the present invention, the graphical user interface (GUI) for the website includes a graphical mapping feature for displaying the location of the construction project. The graphical mapping feature may be configured to receive input, such as a user selection of a point on the map. In an exemplary embodiment, the user first enters location data (e.g., an address) as text, and the website then displays a graphical map with the location indicated (e.g. by an icon) on the map. The user may then confirm the location, or choose to select a more precise location using the mapping application. If the user chooses to select a more precise location using the mapping application, the website may be configured to allow the user to drag the icon representing the construction project location to a new point on the map. In another exemplary embodiment, the mapping feature is used as the primary technique for the user to identify where the project is located.

According to another aspect of a preferred embodiment of the present invention, the scope of coverage for the website and its database will encompass at least a wide geographic area, for example it will encompass at least a large metropolitan area (such as the St. Louis metropolitan area), which means that the website's software logic will take into consideration many different permitting agencies (such as the different county/city/municipal governments within the metropolitan area, the area's different utility authorities, etc.) and their permit applicability requirements. In doing, the scope of coverage for the data structure will encompass a plurality of different types of permits (e.g., building permits, electrical permits, sewer permits, environmental permits, mechanical permits, elevator permits, land disturbance permits, etc.). As such, the website of the preferred embodiment provides tremendous value to users as a single portal through which the user can learn of which permits from among all of the potentially applicable permits are applicable to a construction project.

According to another aspect of an exemplary embodiment of the present invention, users (preferably authorized users) are given administrative control to define the data structure which supports the automated permit applicability determinations. Administrative capabilities may include, for example, creating permits and editing permit information, modifying associations in database tables, creating prompts and prompt response options, linking permits and prompt response options to prompts, linking permits to permitting agencies, determining the order in which prompts will be presented to users, (e.g. by editing the associations that determine the selection of prompts), and entering various other information as described herein. Such a feature provides tremendous value to a practitioner in that it allows the system to be ported and/or expanded in a turnkey manner to encompass new geographical areas. Thus, one practitioner can configure a data structure to encompass the permit applicability requirements for permitting agencies in the St. Louis metropolitan area, and that same practitioner (or another practitioner) can use the administrative feature of system to define another data structure that encompasses the permit applicability requirements for permitting agencies in the Chicago metropolitan area. Further still, the administrative feature allows the system to quickly and easily accommodate any changes that may occur over time with respect to changes in the permit applicability requirements within a region (e.g., changed municipality regulations regarding the applicability rules for a particular permit, new permits that come into existence, etc.).

As such, according to an exemplary administrative embodiment, disclosed herein is an apparatus for administering a data structure, the apparatus comprising: (i) a processor for communication over a network with a user computer, and (ii) a memory in communication with the processor, the memory comprising the data structure, the data structure comprising (1) a plurality of data objects which are representative of a plurality of permits, the permits being potentially applicable to a construction project, (2) a plurality of data objects which are representative of prompts for information about the construction project, (3) a plurality of data objects which are representative of potential prompt responses for the prompts, and (4) a plurality of data objects which associate the prompt responses with the permits such that a software application can query the data structure based on a plurality of user-specified prompt responses which define the construction project to assess which permits can be confirmed as applicable or inapplicable to the defined construction project, wherein the processor is configured to interact with a user of the user computer through a plurality of graphical user interface (GUI) pages to define a plurality of the data objects in the data structure in response to user input.

According to another exemplary administrative embodiment, disclosed herein is a method for administering a data structure, the method comprising: (i) storing a data structure in a computer memory, the data structure comprising (1) a plurality of data objects which are representative of a plurality of permits, the permits being potentially applicable to a construction project, (2) a plurality of data objects which are representative of prompts for information about the construction project, (3) a plurality of data objects which are representative of potential prompt responses for the prompts, and (4) a plurality of data objects which associate the prompt responses with the permits such that a software application can query the data structure based on a plurality of user-specified prompt responses which define the construction project to assess which permits can be confirmed as applicable or inapplicable to the defined construction project, and (ii) interacting with a user of a user computer through a plurality of graphical user interface (GUI) pages to define a plurality of the data objects in the data structure in response to user input, wherein the interacting step is performed by a processor in communication with the computer memory.

These and other features and advantages of the present invention will be apparent to those having ordinary skill in the art upon review of the following description and drawings.

### BRIEF DESCRIPTION OF THE DRAWINGS

FIG. 1 illustrates an exemplary system for providing an interactive website for identifying applicable permits and permitting agencies for a construction project;

FIG. 2 illustrates an exemplary flow diagram for a preferred method of the present invention;

FIGS. 3-7 illustrate exemplary web pages for display to a user of a preferred embodiment as the user interacts with the website of a preferred embodiment;

FIGS. 8-14 illustrate exemplary web pages for display to an administrator of a preferred embodiment;

FIGS. 15(a)-15(f) depict exemplary database tables in accordance with an exemplary embodiment; and

FIG. 16 depicts an exemplary process flow diagram which illustrates an exemplary technique for selecting which prompts to present to a user.

### DETAILED DESCRIPTION OF THE PREFERRED EMBODIMENTS

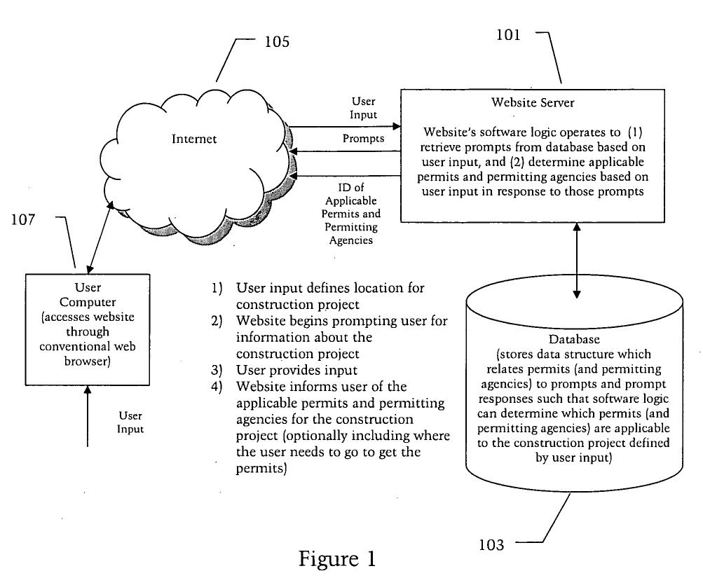

FIG. 1 illustrates an exemplary interactive system for determining and identifying the applicable permits for a construction project. In this exemplary embodiment, the system comprises a processor 101 that is in communication with a user computer 107 over a network 105 such as the Internet. Processor 101 is also in communication with a memory 103 to support the processing of input received from the user computer 107 through the network 105.

User computer 107 may take the form of any computer or other device capable of connecting to the network 105. As an example, user computer 107 can be a standard personal computer (PC) that is connected to the Internet and running a conventional web browser program (such as Internet Explorer). The user for user computer 107 is preferably a contractor, contractor employee/agent, subcontractor, subcontractor employee/agent, etc.

Processor 101 may take the form of a server which hosts a website. Thus, a user of the user computer 107 can access pages of the website hosted by the server over network 105. An example of a suitable website server which can be used in the practice of FIG. 1 is any server-grade computer running a variation of the Linux operating system with Apache web server software, PHP interpreter software, and a mySQL database. However, it should be understood that other server hardware and software can be used. A software application as represented by software code resident on a computer-readable storage medium (e.g., computer memory such as RAM, a hard drive, a CD-ROM, etc.) is executed by the processor 101 to host and operate the interactive website of the preferred embodiment.

A memory 103 in communication with the processor 101 is configured to provide the processor 101 with the necessary information to determine which permits are applicable to a construction project. To support this, memory 103 preferably stores (1) a plurality of data objects that are representative of the potentially applicable permits for construction projects which may be located over a wide geographic area such as a large metropolitan area, (2) a plurality of data objects which are representative of the prompts for information to be displayed on a user computer to solicit information about a construction project which is pertinent to the applicability/inapplicability of the permits, (3) a plurality of data objects which are representative of the potential responses to the prompts, (4) a plurality of data objects which associate permits with prompts and potential prompt responses based on the permit applicability requirements of the pertinent permitting agencies, and (5) a plurality of data objects which define the conditions under which the permits can be confirmed/excluded as applicable/inapplicable with respect to a construction project. Together, these data objects form a data structure within memory 103 such that the software executed by processor 101 can determine which permits are applicable to a construction project that is defined based on the user responses to the prompts. Preferably, this data structure also includes (1) data objects which are representative of the permitting agencies which have jurisdictional authority over the permits, and (2) data objects which associate the different permitting agencies with the permits. The data objects may take the form of one or more bits depending on how many bits are needed by the data object to represent its underlying information.

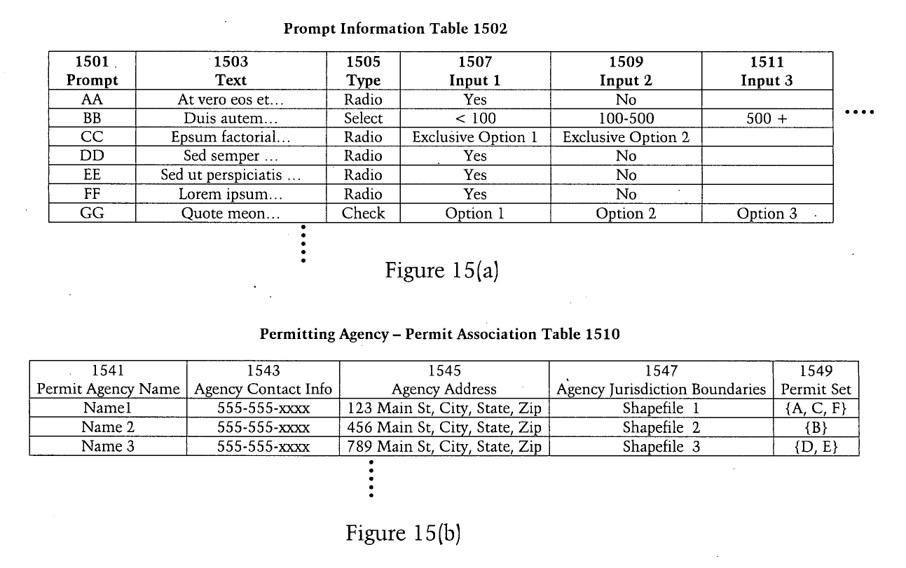

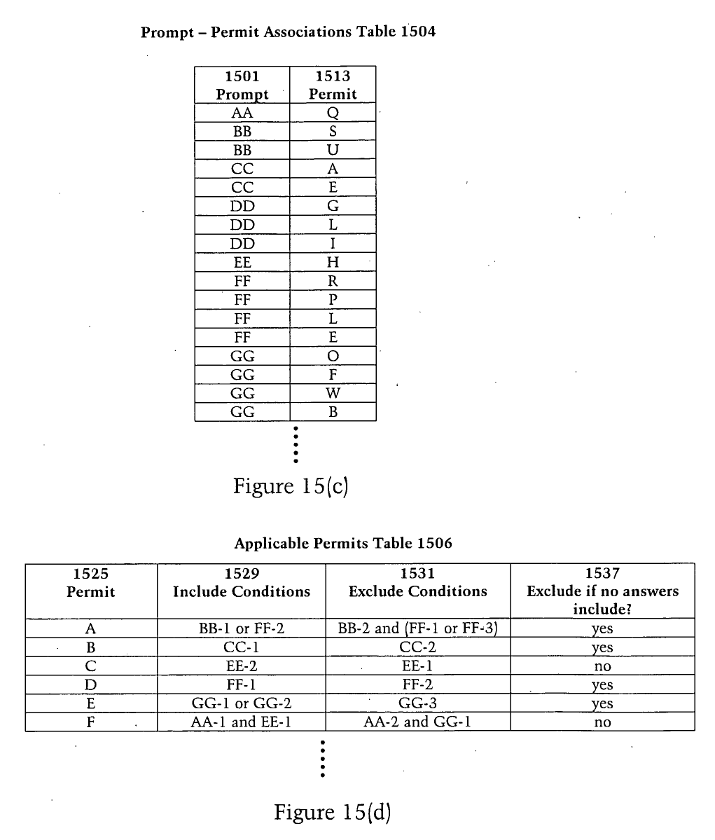

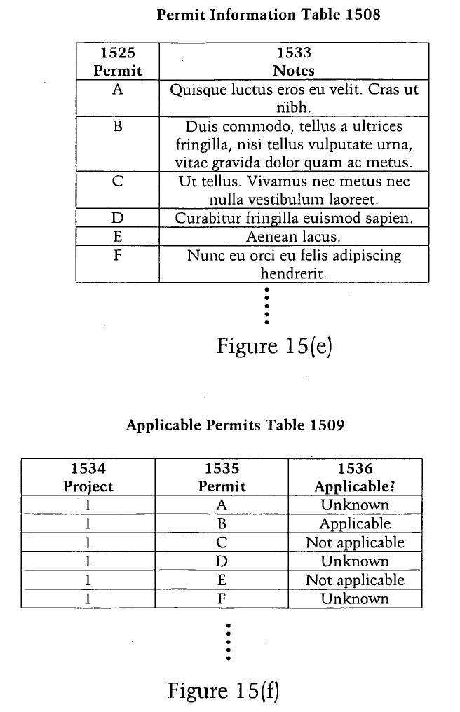

Memory 103 may be resident on the website server or it may be resident on a device separate from but in communication with the website server. Further still, a portion of memory 103 may be resident on the website server and another portion of memory 103 may be resident on a device separate from but in communication with the website server. Also, memory 103 may take the form of a database, preferably a relational database. An example of a suitable relational database would by a mySQL database. In the event of high loads caused by large numbers of concurrent users, the data structure stored in the relational database may be located on one or more separate servers to facilitate load balancing and improver user response times. The database may include a table for storing associations between permits and permitting agencies, a table for storing associations between permits and prompts and prompt response options, and a table for storing associations between permits and conditions for confirming and/or excluding the applicability of the permit to a defined construction project. Exemplary database tables for the data structure of memory 103 are depicted in FIGS. 15(a)-15(f), which are described in greater detail below.

### Basic Website Operation:

In operation, the website server receives user input comprising information about a construction project. Preferably, this begins with the user identifying the location for the construction project. Based on this information, the website server begins prompting the user for information about various aspects of the construction project, and allows the user to enter input to indicate a response to the prompt. The website server processes the received information and determines the appropriate prompts to next present to the user to further resolve which permits will be needed for the construction project. After several iterations of this process, the website server informs the user of all the applicable permits (and preferably permitting agencies) for the construction project. Optionally, this information may include information about where the user needs to go to obtain the applicable permits.

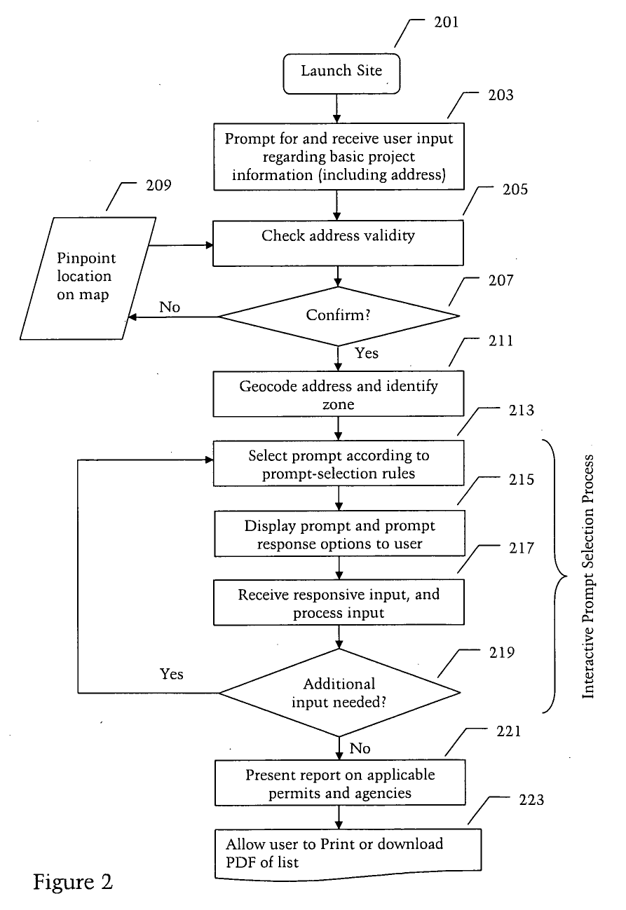

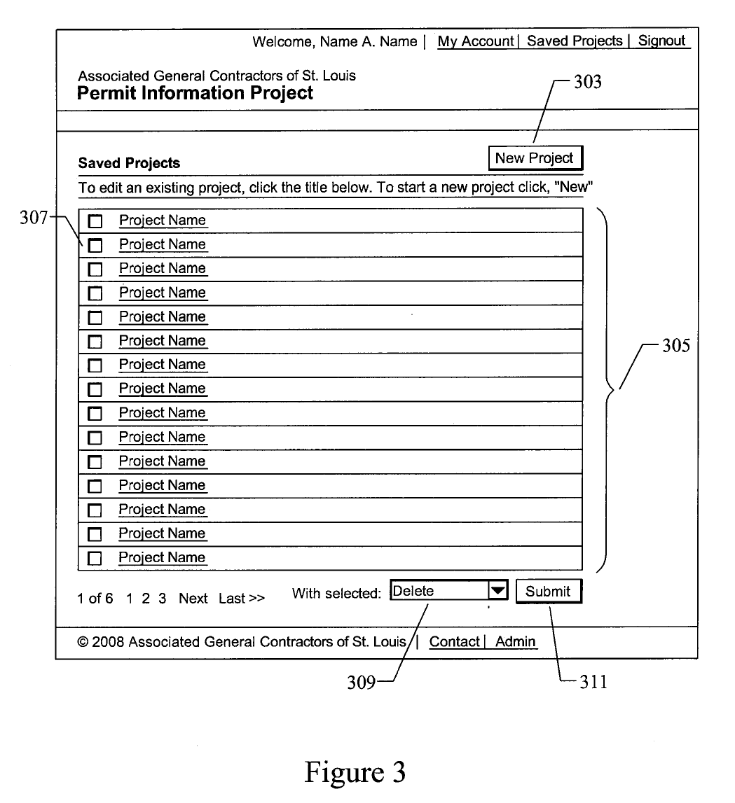

FIG. 2 illustrates an exemplary flow diagram for a preferred method of the present invention. At step 201, a user launches the website, e.g. by using a web browser (e.g. internet explorer) to access a Uniform Resource Locator (URL) for the website. Optionally, the website greets the user with an introductory web page that allows the user to log in to the website or create an account. Techniques for managing user accounts are well-known in the art and can be used to practice this aspect of step 201. After the user has logged into the website, the user is preferably given the option of using the website to update information for a saved project or enter information for a new project. FIG. 3 depicts an exemplary web page that can be provided by the website for display on the user computer 107 for the user to choose whether to work on a saved project or start a new project. This page shows an exemplary list 305 of saved projects which are associated with that user. Preferably, access to saved projects is restricted to particular users so that a saved project will only be accessible to users who have logged in to an account that is authorized for that project. Thus, when a user is a contractor, that contractor will only have access to saved projects corresponding to its own construction projects. Optionally, the list 305 may also represent all of the projects for which data is stored in the system.

A user may add and begin entering information for a new project by selecting the “New Project” button 303. A user may also select an existing project by checking one of the boxes next to its name (e.g. box 307). The user can then choose an operation from drop-down menu 309 and perform the operation on the selected project using the submit button 311. For example, the user may choose to edit a project by selecting its box and choosing “edit” from drop-down menu 309 and then selecting submit button 311. A user may also request to edit the information associated with an existing project by clicking the project name. When accessing a saved project for editing purposes, the user may be presented with previously-entered data for the project and given the opportunity to make changes. From the page of FIG. 3, the user may also choose to delete a project by selecting “delete” from drop-down menu 309 and selecting submit button 311, which will delete the project from the system database.

If the user chooses to start a new project, the method progresses to step 203. At step 203 the system prompts the user for input regarding basic information about the construction project, including the location of the project. As an example, this location can be defined by user entry of an address for the project, a nearest crossroads for the project, or an address that is nearby the project. However, it should be understood that other location-defining techniques can be employed. The “basic” project information solicited from the user at step 203 is preferably information that can be considered “static” for the project, e.g., data that is not likely to change throughout the life of the construction project. Examples of project information that can likely be classified as “static” include the project's location, whether the project is for residential or commercial property, the size of the property for the project (e.g., acreage), and the overall size of the project itself (e.g., square footage).

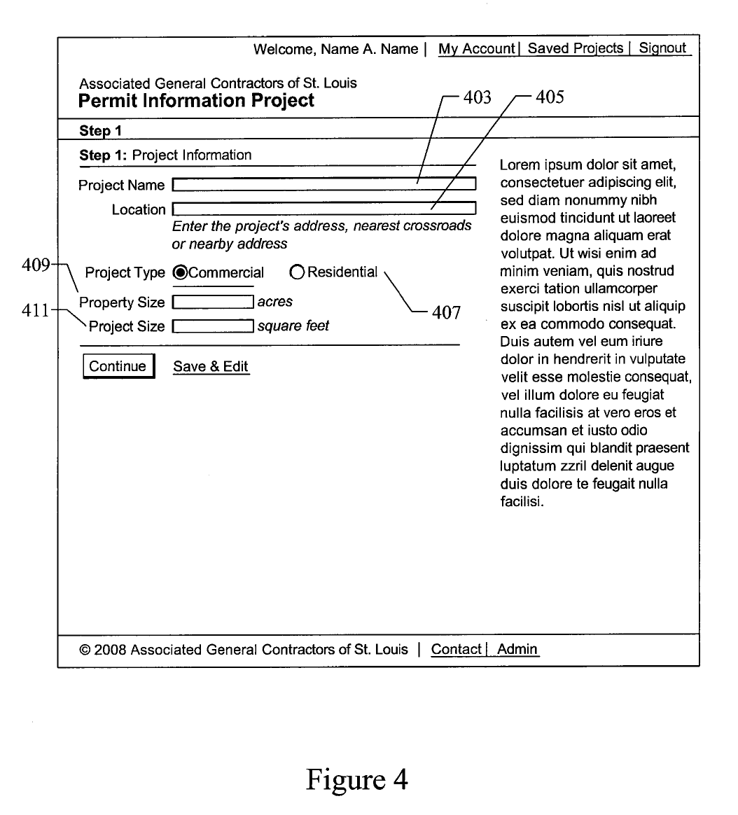

FIG. 4 depicts an exemplary page which can be provided by the website server for display on user computer 107 to solicit the basic project information. As shown in FIG. 4, this page may include a field 405 for user entry of a location for the project, a field 407 for user entry to define whether the project is for residential or commercial property, a field 409 for user entry of a property size for the project, and a field 411 for user entry of the project size. Optionally, such a page may also include a field 403 for user entry of a name for the project. The system can then use this project name to help identify the project to a user should the user need to later re-enter the website to edit any of the project's pertinent details (such as displaying the project name on list 305). Once the user has filled in the data fields as appropriate on the page of FIG. 4, that user can select the “Continue” button to continue the process of providing information to the website server about the construction project. The user may also select the “Save & Exit” link on the page to save the information entered on the page but otherwise exit the interactive path of the website. Upon selection of either the “continue” button or the “Save & Exit” link, the website server preferably creates a record in memory 103 for that project, wherein this record contains the responses to the prompts present on the page of FIG. 4.

Furthermore, upon selection of the “Continue” button of FIG. 4, at step 205 the system checks the validity of the received location information. As an example, the location information can be in the form of an address as text in a postal address format comprising street address, city, state, and zip code. Step 205 checks the validity of this address using techniques known in the art. If the address is invalid, the system may request that the user check the address, or alternatively, the system may proceed to step 209 to allow the user to select the location using a graphical mapping application. An example of a suitable graphical mapping application for use with step 209 is the ArcGIS Server application provided by ESRI of Redlands, Calif. The ArcGIS Server application is a stand-alone application that runs on a separate server (wherein the website server is able to communicate with this separate server over a network such as the Internet.).

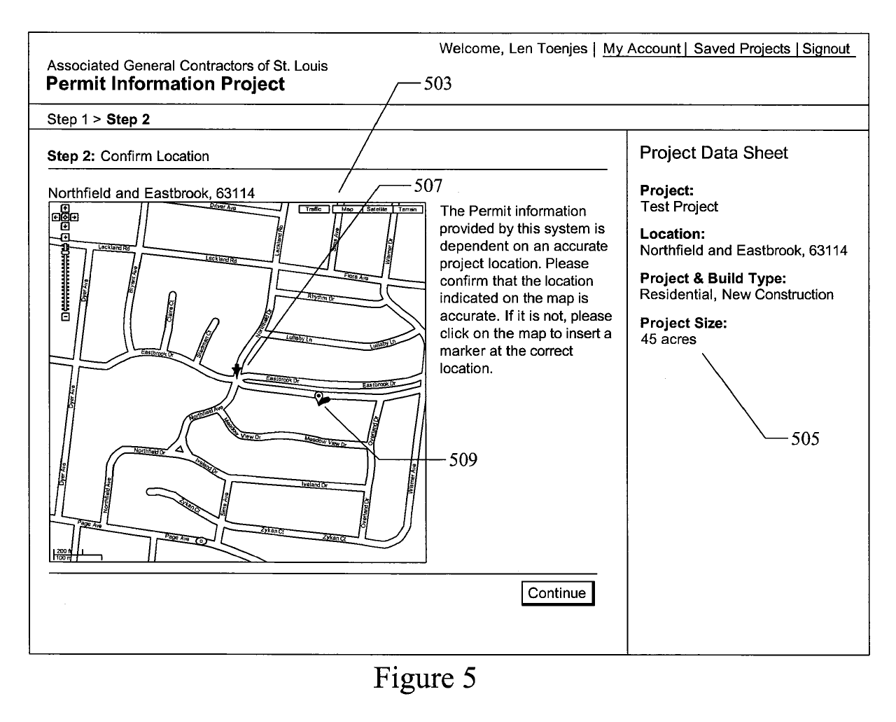

At step 207, the website server asks the user to confirm that the location is correct. As part of this step, the website server preferably visually displays the user-specified location on a map, as shown in FIG. 5. If the user confirms that the current location is correct, then the system proceeds to step 211. Otherwise, the system proceeds to step 209. At step 209 the system provides a graphical mapping application that allows the user to input location information by indicating a point on the map. It should be understood that specifying a proper location for a construction project is of utmost importance for the website server to be able to identify which permitting agencies have jurisdictional authority over the permitting for the project. By providing a confirmatory page for confirming the accuracy of the user-specified location, the method of FIG. 2 provides an advantage in greatly reducing the likelihood of a user beginning the process of providing project information to the website server while relying on mistaken assumptions about where the project is located. Moreover, by using a graphical map in this confirmatory step, the inventors herein believe that the likelihood of error in specifying the project's location will be yet further reduced.

As noted, FIG. 5 depicts an exemplary page for receiving and confirming location information from a user using a graphical mapping application 503. As can be seen from section 505 of the page, which serves as a summary of the user-specified basic project information, the user has previously entered an address for the project of “Northfield and Eastbrook, 63114”. Graphical mapping application 503 displays an icon 507 on the map at this location. Graphical mapping application 503 may be an interactive application that allows the user to input a new location. For example, the user may be able to select a new location 509 by clicking on the map. Optionally, the user may be able to drag icon 507 to a new location. The mapping interface may be any of a number of commercially-available graphical mapping applications such as that provided by the ArcGIS Server application discussed above.

At step 211, the system then geocodes the user-specified location and identifies the “zone” for the construction project. This geo-coding is preferably performed by commercially available software such as the ArcGIS Server application discussed above. The geo-coding converts the location information (such as an address) to a latitude and longitude. The identified zone for the construction project signifies a unique intersection of the territorial boundaries of all permitting agencies having jurisdiction over the determined latitude/longitude for the construction project. The system may then use this precise location data (as well as the other basic information received at step 203) to determine the initial set of potentially applicable permits.

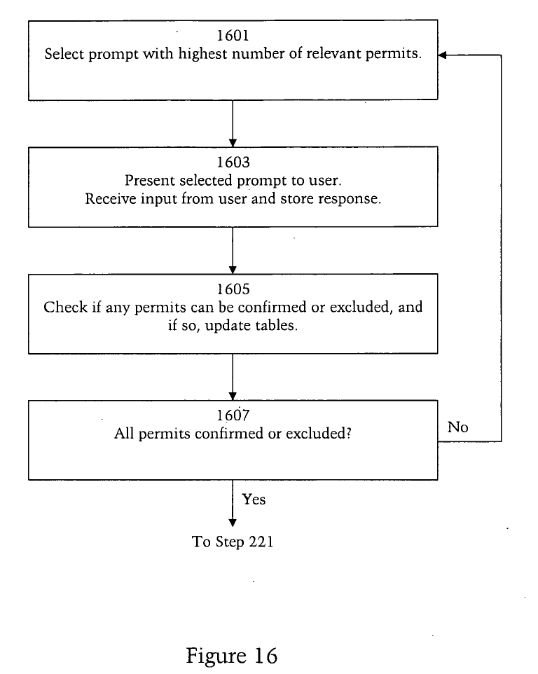

At step 213 the website server selects a prompt for display to the user. The rules for prompt selection are described in greater detail below with reference to FIG. 16. To perform this selection, the website server preferably queries the data structure stored in the database based on the previously-specified project information.

At step 215, the system provides a page for display on the user computer, wherein this page displays the selected prompt, the associated prompt response options, and one or more fields for user entry to select one or more of the displayed prompt response options.

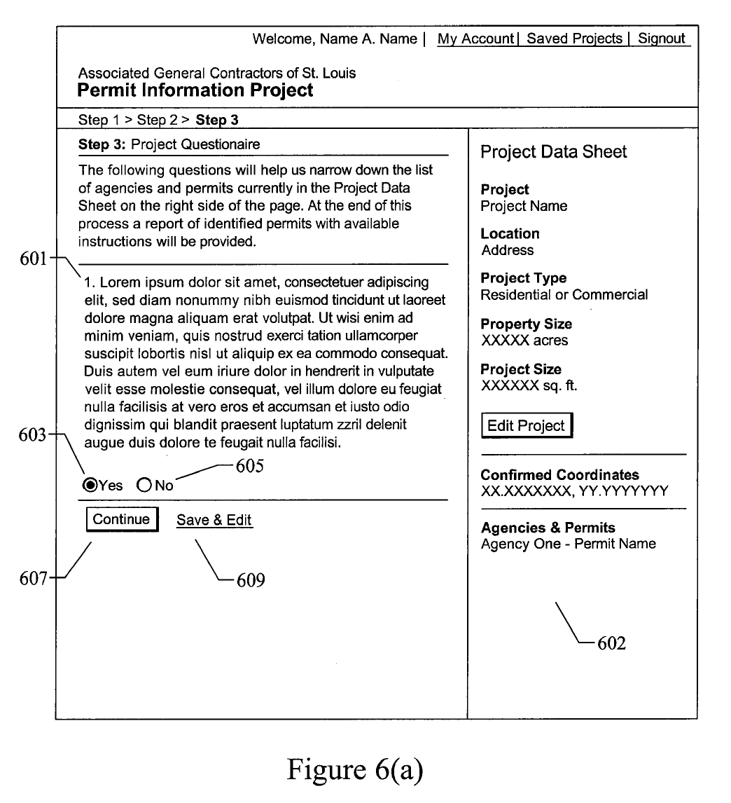

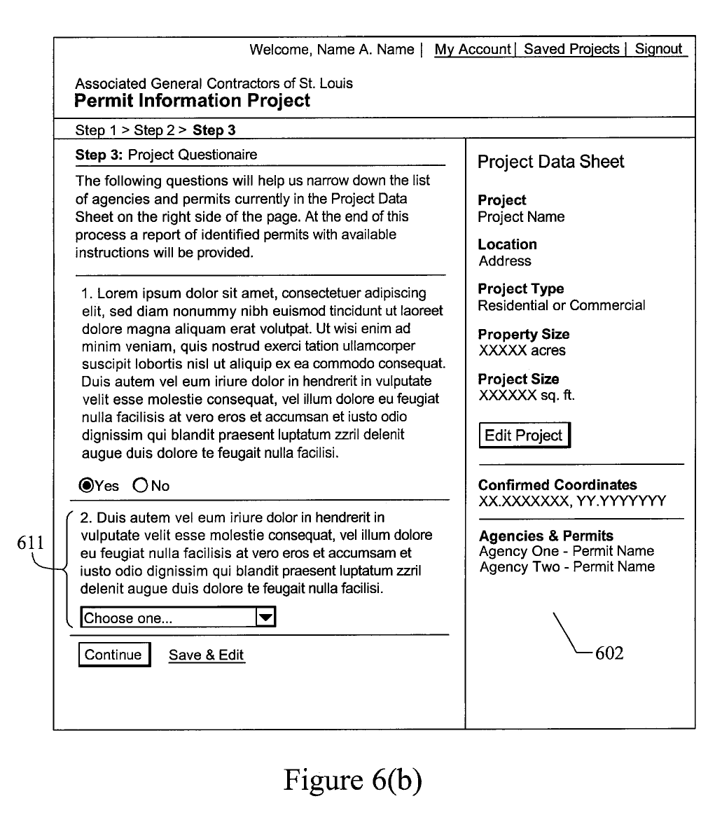

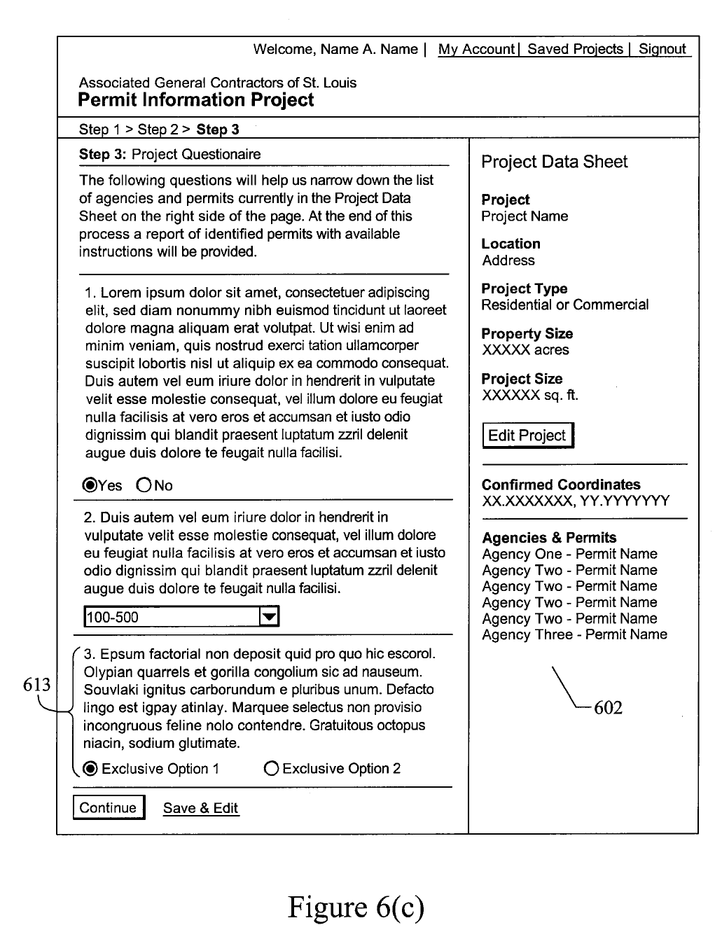

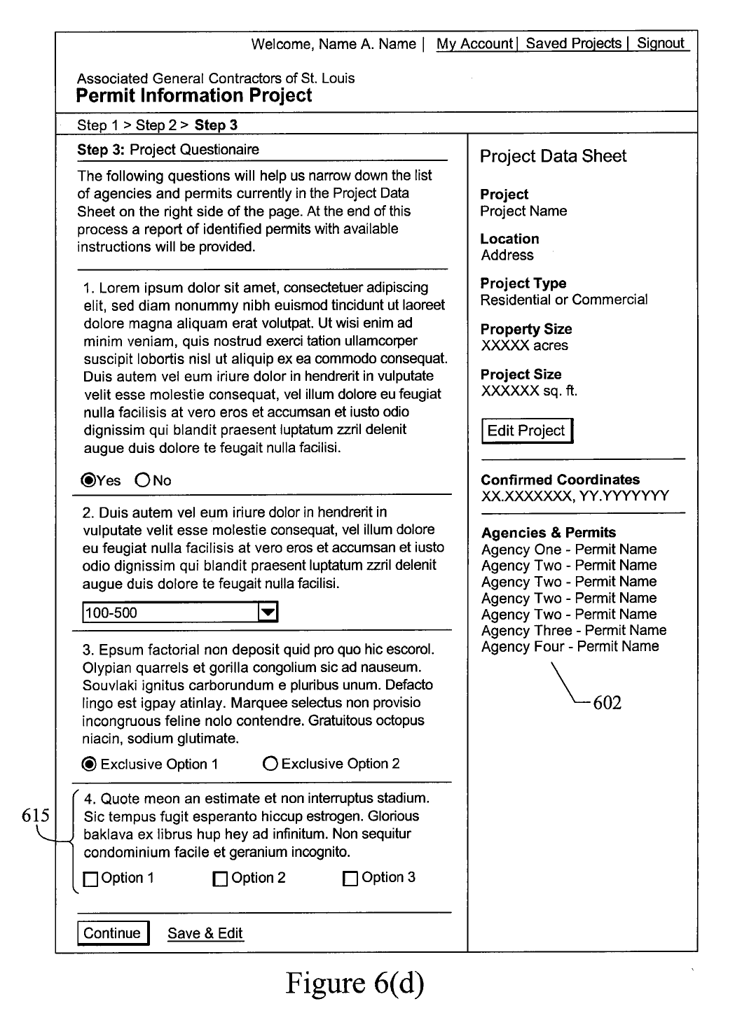

FIG. 6(a) depicts an exemplary page which displays a prompt, prompt response options, and fields for user entry. Section 601 of the page of FIG. 6(a) depicts an exemplary prompt for information selected from the data structure. This prompt preferably takes the form of a question (e.g., “Will the building have a steel frame?”). However, it should be understood that other sentence structures can be employed (such as a declarative statement “This project will have a ______ frame”, with the prompt response options being fill-in the blank answers (e.g., steel, wood, etc.)). As explained below, the text for the prompt in section 601 is preferably stored in the data structure for the website.

The page of FIG. 6(a) also preferably includes a section which displays the options for responding to the prompt. In this example, the options take the form of yes/no options 603 and 605, with the user entry fields taking the form of radio buttons associated with the yes/no responses. However, it should be understood that other forms of prompt response options and user input fields can be used, such as range selection options, exclusive multiple choice options, nonexclusive multiple choice options, etc. The text for the prompt response options as well as the structure for accepting user input is preferably stored in the data structure for the website, as explained below.

Also displayed on the page of FIG. 6(a) is a summary section 602 which provides a running summary of the project information submitted thus far (including a display of the confirmed location coordinate) and a running summary of which permits are still potentially applicable to the construction project defined by the previously-received information. It should further be noted that should the user need to edit any of the previously-entered project information, the user can start such an editing process by selecting the “Edit Project” button within section 602. Upon selection of the “Edit Project” button, the website server preferably provides a page for display on the user computer that is configured to display all previously-displayed prompts and prompt responses for the project, together with user entry fields for modifying the prompt responses if necessary.

At step 217, the website server receives user input in response to the selected prompt and stores the received input, e.g. stores the selected prompt response option(s) in the record opened for the project. The website server preferably receives this input following user selection of the “Continue” button 607 or user selection of the “Save & Exit” link 609. Moreover, upon selection of the “Continue” button 607, the website server proceeds to step 219 of FIG. 2. Upon selection of the “Save & Exit” link 609, the website server need not progress to step 219 and instead need only save the submitted prompt response to the project record.

At 219 the system determines whether additional information about the project is still needed in order to determine all applicable permits. As explained in greater detail below, this determination can be made by querying the data structure for the website based on the previously-received project information. For example, the system may query the database to determine whether any permits remain unconfirmed. If there are no permits remaining unconfirmed, the system may proceed to step 221. If some permits are still unconfirmed, then the system may loop back to step 213 to continue the iterative session with the user.

FIGS. 6(b)-(d) illustrate exemplary pages for display on the user computer 107 as the website server continues the interactive session with the user. In the example of FIG. 6(b), it can be seen that a new prompt has been selected for display, as shown in section 611 (e.g., “How many electrical outlets will be included in the building?), together with the prompt's response options and corresponding user entry field. Also, it can be seen that section 602 has been updated to reflect the information provided by the user in response to the prompt of FIG. 6(a). FIG. 6(c) depicts yet another page which includes a section 613 with a new prompt (e.g., “What type of roof will be used for the building?), prompt response options and corresponding user entry fields. Once again, it can be seen that section 602 in FIG. 6(c) has been updated to reflect the prompt response submitted by the user in connection with FIG. 6(b). FIG. 6(d) depicts yet another page which includes a section 615 for displaying a new prompt, prompt response options, and corresponding user entry field(s).

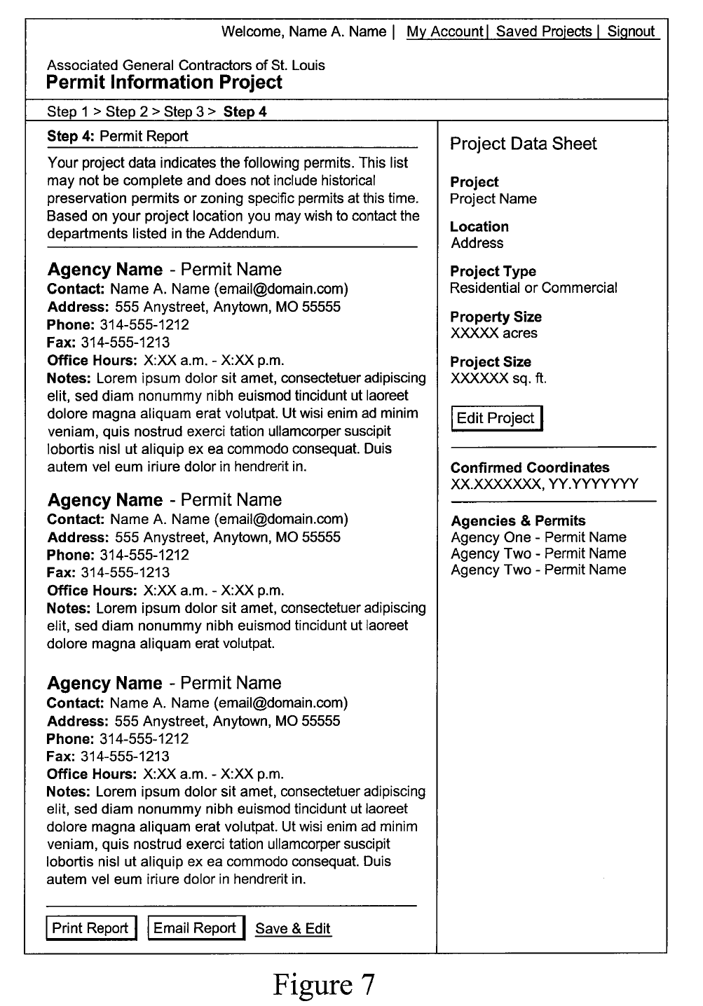

When the website server reaches step 221, this means that the software has been able to rule in or rule out all potentially applicable permits for the defined construction project. Thus, at step 221, the system presents a page for display on the user computer 107 which serves as a report of all the permits that have been confirmed as applicable. An exemplary such page is depicted in FIG. 7. FIG. 7 includes a list of the applicable permits for a construction project that is presented to the user. Preferably, this report identifies each permit that is needed by name and by the permitting agency which grants that permit. This information preferably includes contact information for the permitting agency that helps inform the user about how to go about securing the permit. Optionally, the report may include any “notes” stored by the system about each permit, which may take virtually any form (such as an insightful information learned over time about the relevant permit (e.g., the expected processing time for the permits as learned from past experience, etc.). The page of FIG. 7 also preferably provides the user with the option to print the report, email the report, or download the report in a Portable Document Format (PDF) format or the like (step 223).

### Website Data Structure:

FIGS. 15(a)-(f) illustrate an exemplary data structure for supporting the website's operation. The software logic of the website preferably interacts with the data structure using queries. For example, the software logic may generate SQL queries and submit these queries to the data structure to determine which prompts should be selected for presentation and determine which permits are applicable or inapplicable to the defined construction project.

FIG. 15(a) depicts an exemplary database table 1502 for storing information corresponding to each prompt. Prompt information table 1502 preferably contains a row for each prompt, including a prompt label 1501, corresponding prompt text 1503, prompt response option type 1505, and prompt response options text fields 1507, 1509, 1511 . . . forming columns within each row. Thus, column 1503 defines the text for each prompt to be displayed by the website server on the website pages during the interactive prompt selection process of FIG. 2. Column 1505 defines the type of prompt response options to be presented to the user (e.g., radio buttons, range selections, nonexclusive check boxes (for nonexclusive multiple choice prompts, etc.), and columns 1507, 1509, 1511, . . . define the text for the prompt response options as needed (e.g., fields 1507 and 1509 would be needed for the text of a response to a yes/no prompt, while more fields may be needed for the prompt response text options for a range selection prompt).

For example, in FIG. 15(a), prompt “AA” is associated with the text “At vero eos et . . . ” and prompt response options text “Yes” and “No”, which are of the type “radio buttons”. In an exemplary embodiment, the selection of a “Yes” response by a user to Prompt “AA” can be stored as in memory as “AA-1” (because “Yes” is in column “Input 1” 1507) while a “No” response can be stored as “AA-2” (because “No” is in column “Input 2” 1509). In this fashion, the system can track and store all responses received to the displayed prompts (and use those answers to query the data structure when determining which permits may be applicable and which prompts should next be selected for display. However, it should be understood that a variety of other mechanisms can be used to store user input in memory, as will be apparent to those of ordinary skill in the art following the teachings presented herein.

FIG. 15(b) depicts an exemplary database table 1510 for storing permitting agency-to-permit associations. Each row of table 1510 corresponds to a different permitting agency, with columns for identifying permitting agency name 1541, contact information 1543, address 1545, jurisdictional boundaries 1547, and the set of permits 1549 over which the permitting agency has jurisdictional authority. The boundary information in column 1547 allows the website server to determine whether a particular permitting agency has jurisdictional authority over a construction project based on the location information provided by the user during the flow of FIG. 2. The boundary information represented in column 1547 preferably takes the form of industry standard shapefiles, such as ESRI shapefiles, which is a geospatial vector data format for geographic information systems (GISs). The shapefile associated with a particular permitting agency defines the geographical extent of that permitting agency's jurisdiction. The ArcGIS Server application (or similarly configured commercially-available software) then processes a construction project's geo-coded location information to determine whether the location falls within the boundary defined by the shapefile. Preferably the data in column 1547 is a name, identification number or other pointer to the shapefile associated with the corresponding permitting agency. Also, the set of permits identified in column 1549 identify each permit that the permitting agency has authority to grant within its jurisdiction.

FIG. 15(c) depicts an exemplary database table 1504 for storing permit information corresponding to each prompt. Prompt-to-permit associations table 1504 contains a plurality of rows, with each row corresponding to a prompt, and includes data in column 1513 to identify which permits are relevant to the project information solicited by that prompt. For example, prompt “AA” is associated with permit “Q”, while prompt “BB” is associated with permits “S” and “U”, as exemplified by the two rows associated with prompt “BB”. In the exemplary table of FIG. 15(c), it can be seen that prompt “FF” has the highest number of relevant permits at four. As can be seen from the table, permits “R”, “P”, “L”, and “E” are relevant to prompt “FF”. Thus, it should be understood that prompt “FF” can be characterized as carrying a greatest weight with respect to resolving which permits may be applicable to a construction project in an exemplary weight scoring algorithm. To resolve which prompts carry the greatest weight, the software preferably dynamically queries the database, including table 1504, to determine the totality of prompts that are required to confirm all of the eligible permits. The software then dynamically sorts the selected prompts in descending order based on the number of permits associated with each prompt starting with the prompt associated with the greatest number of prompts. When resolving ties between prompts with an equal number of permit associations, any of a number of tiebreaking mechanisms can be used. For example, the system can select from among the equally-weighted prompts by selecting the equally-weighted prompt which had a higher order when they were returned by the database query. In an alternative embodiment, the database can maintain a separate dynamic weight table for each prompt which dynamically tracks how many unconfirmed permits are associated with each prompt, wherein the software would then rely on this table to find which prompt carries the greatest weight.

FIG. 15(d) depicts an exemplary database table 1506 for storing the applicability requirements for permits. The applicability requirements are preferably defined by include conditions (to define the conditions, if met, that allow the software to confirm a permit as applicable to a construction project) and exclude conditions (to define the conditions, if met, that allow the software to confirm a permit as inapplicable to a construction project). Column 1529 in table 1506 defines the “Include Conditions” for each permit. The “Include Conditions” are preferably configured to identify the prompt responses that are needed to determine that the corresponding permit can be confirmed as “applicable” to a defined construction project. Similarly, column 1531 defines the “Exclude Conditions” for each permit. The “Exclude Conditions” are preferably configured to identify the prompt responses that are needed to determine that the corresponding permit can be confirmed as “inapplicable” to a defined construction project.

The system preferably stores the session data for a project in a separate table, wherein the session data identifies the prompts that were presented to the user and the prompt responses received from the user. Thus, as part of step 217 in FIG. 2, the software application can query table 1506 with the session data to determine whether any permits can be confirmed as applicable or inapplicable based on the current state of the user input which defines the construction project. For example, permit “B” is associated with an include condition of “CC-1”. This indicates that if the system receives a response to prompt “CC” of “Exclusive Option 1”, then permit “B” is confirmed as applicable to the construction project. By way of further example, permit “B” is associated with an exclude condition 1531 of “CC-2”, which indicates that if a response to prompt “CC” of “Exclusive Option 2” is received, then permit “B” is excluded, i.e. confirmed to be NOT applicable. As the project record is updated each time the user provides a response to a displayed prompt, table 1506 can be queried once again at step 217 until all permits have been confirmed as applicable or inapplicable. the flagpole permit

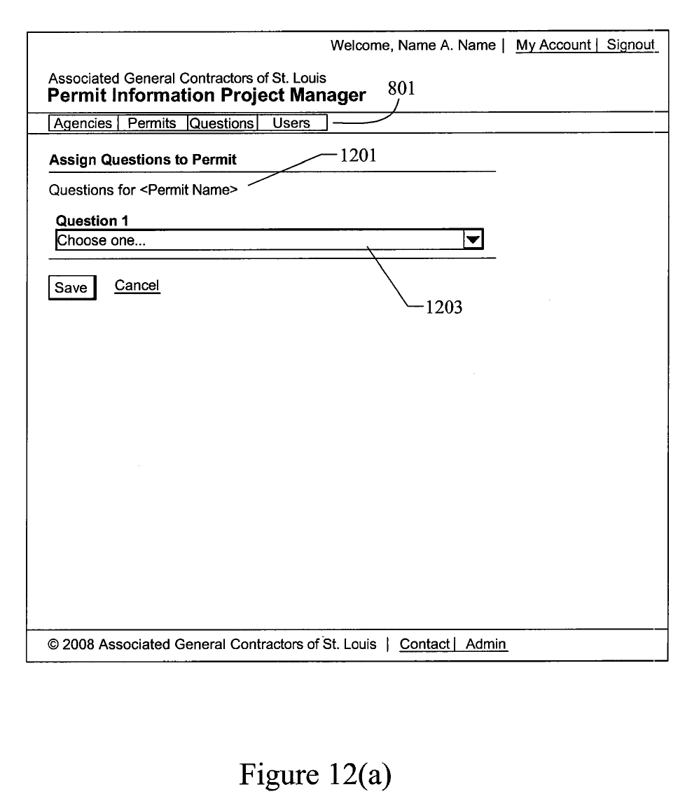

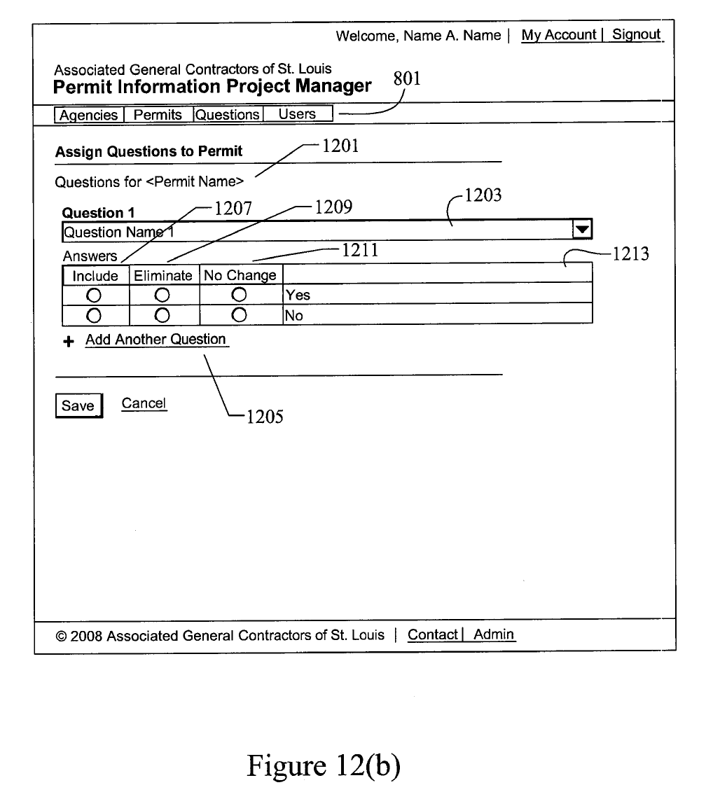

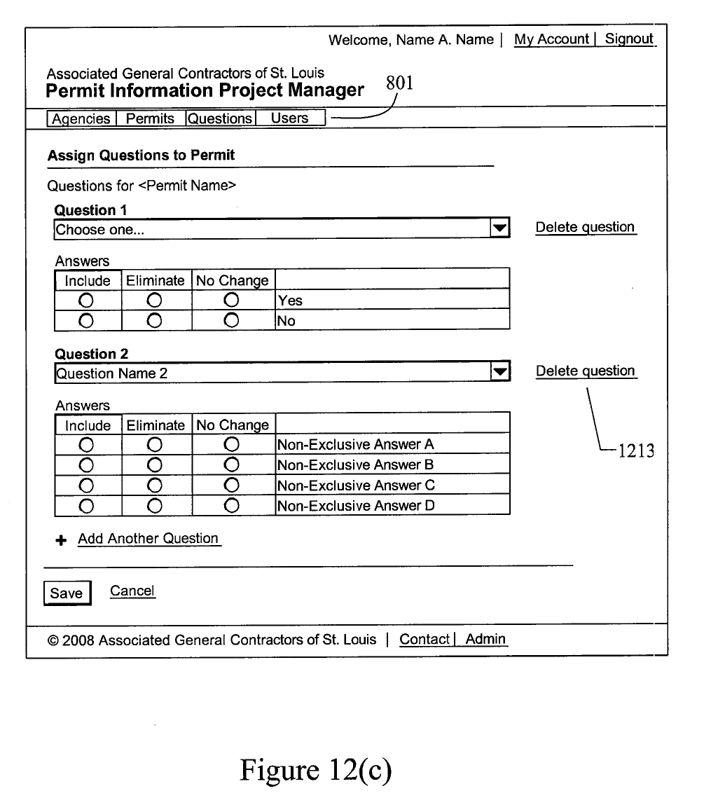

Optionally, table 1506 of FIG. 15(d) includes a column 1537 to identify whether a permit should be confirmed as inapplicable if no prompt responses for the prompts associated with that permit are marked as “Include” responses (see FIGS. 12(b) and (c)).

A similar column (not shown) to signify whether a permit should be confirmed as applicable if no prompt responses for the prompts associated with permit are marked as “Eliminate” responses can be employed in table 1506. This column can also be helpful for determining the applicability of any permits for which an automatic applicability determination is impossible. For example, if a fire district permit includes an applicability requirement to the effect of the permit being needed if the building will have more than X number of occupants and the fire marshal believes the permit is needed, then a prompt about the construction project cannot resolve the fire marshal's subjective assessment. In such an instance, if the extra column is used, the prompt response of “>X” for the fire permit with respect to how many occupants there will be for the building need not be marked as “Include”. So long as the fire permit has not been excluded, the extra column would allow the website to still identify the fire permit as a “maybe” permit (with such “maybe” permits preferably being reported to the user).

FIG. 15(e) depicts an exemplary database table 1508 for storing information associated with each permit. Permit information table 1508 preferably includes a row for each permit with a column 1525 for permit name and a column 1533 for permit notes. As explained in connection with FIG. 7, the permit notes column 1533 can be populated with text for any notes that are to be displayed in the website's output report.

FIG. 15(f) depicts an exemplary database table 1509 for storing data about the applicability of permits to a construction project. Each row of table 1509 preferably corresponds to a project, as identified by column 1534. Column 1535 identifies a permit whose applicability or inapplicability to a project is defined by table 1509. Preferably, table 1509 includes a row for each possible project-permit combination. However, it should be noted that table 1509 can optionally be constructed once the user supplies the basic project information (e.g., location) at step 203. Column 1536 identifies for each permit in column 1535 whether the permit's status with respect to a project is “Unknown” (i.e., unconfirmed), “Applicable” (i.e., confirmed as applicable), or “Not applicable” (i.e., confirmed as inapplicable). The entries in column 1536 are preferably dynamically updated by the software in response to the processing mentioned above in connection with step 217 against table 1506. Preferably, permits are treated as “Unknown” in column 1536 until confirmed as applicable or inapplicable. Moreover, step 219 of FIG. 2 preferably operates to query table 1509 to assess whether any permits for the project still have an “Unknown” status. If so, the interactive prompt selection process of FIG. 2 will continue.

Optionally, as permits are confirmed as applicable or inapplicable, the software can update a dynamic weight table as discussed above to reflect the permits for which there is no longer a need to solicit information. Thus, if unselected prompt QQ is initially associated with Permits 1, 5, and 7, the initial weight for prompt QQ will be 3. However, if previous user prompt responses are such that the software has been able to confirm Permit 5 without the need to present prompt QQ, then the dynamic weight table's entry for prompt QQ can be updated to a new value of 2.

It will be apparent to those of ordinary skill in the art that a variety of database implementations will be consistent with the invention, and that the invention is not limited to the exemplary database tables shown in the figures. For example, each prompt may be associated with more than 3 input options, and more than 4 permits. Similarly, it will be apparent that the system is not limited to 6 permits as depicted in these figures.

### Interactive Prompt Selection Process:

FIG. 16 depicts an exemplary flow chart for the interactive prompt selection process of FIG. 2 in an exemplary embodiment. With reference to FIG. 2, step 213 preferably employs a “greatest weight prompt” as the prompt selection rule. That is, at step 1601, the system preferably dynamically queries the database and session data, including table 1504, to determine the totality of unpresented prompts that are required to confirm all of the eligible permits. The software then dynamically sorts the selected prompts in descending order based on the number of permits associated with each prompt starting with the prompt associated with the greatest number of prompts. The highest ranking prompt is then selected for presentation to the user. In an alternative embodiment, the database can maintain a separate dynamic weight table as previously explained, wherein the software would then rely on this table to find which unpresented prompt carries the greatest weight.

Having selected the prompt with the highest number of relevant permits, the system proceeds to step 1603 where the selected prompt is displayed to the user, and a user response to the prompt is received (see FIGS. 6(a)-(d)). As part of step 1603, the system updates the session data for the project to indicate that the selected prompt has been presented. The system also stores the user's response to the displayed prompt in the session data.

At step 1605 the system processes the user's response to the displayed prompt to check whether any permits can be confirmed based on the responses received so far, including the newly received response and all previously-stored responses. This analysis is performed according to the “Include Conditions” 1529 and “Exclude Conditions” 1531 stored in table 1506. For example, if prompt “CC” is presented to the user, and the user responds by selecting “Exclusive Option 1” which corresponds to “Input 1” 1507 for prompt “CC” (as can be seen in FIG. 15(a)) then the system may store this response as “CC-1” in the session data. The system would then search table 1506 for any permits with include conditions 1529 or exclude conditions 1531 that contain “CC-1” to aid the process of confirming permits as applicable or inapplicable. If all include or exclude conditions of a permit are present in the session data for the project, then the software can confirm that permit as applicable or inapplicable and update table 1509 accordingly. In the example of FIG. 15(c), the system would discover that “CC-1” is contained in the include conditions 1529 for permit “B”. Thus, the system would set the entry in column 1536 for permit “B” and that project to “Applicable” to indicate that permit “B” has been confirmed applicable to the construction project. Optionally, because permit “B” has been confirmed as applicable to the project, the relevance of Permit “B” can be ignored when selecting future prompts (by way of updating a dynamic weight table as discussed above).

At step 1607, the software then queries table 1509 to determine whether any permits for the project still have a status of “Unknown” in column 1536. If any “Unknown” permits still exist, the process returns to step 1601. Otherwise, the software has determined the applicability of all permits for the construction project and proceeds to step 221.

Various alternative implementations to the process of FIG. 16 will be apparent to those of ordinary skill in the art, but are still within the scope of the invention.

### Website Administration:

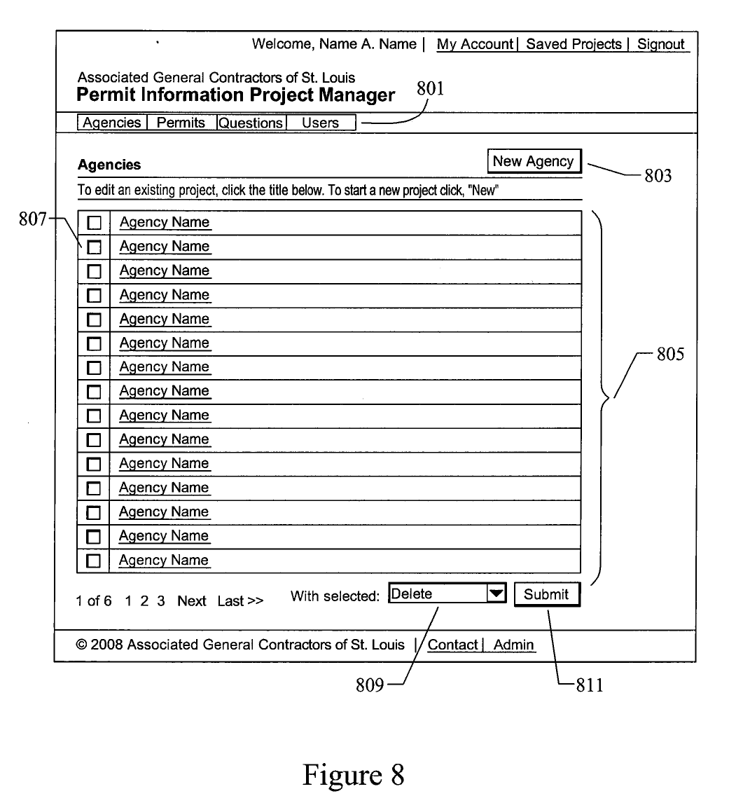

FIGS. 8-14 illustrate exemplary web pages for display to an administrator of a website to provide that administrator with control over the content of the data structure in memory 103 and to control which users have access to which projects. Preferably an administrator user or “admin” would be required to log in to the server from a user computer 107, e.g. by entering a username and password, as is well known in the art. An admin preferably has abilities beyond those of an ordinary user, as described below.

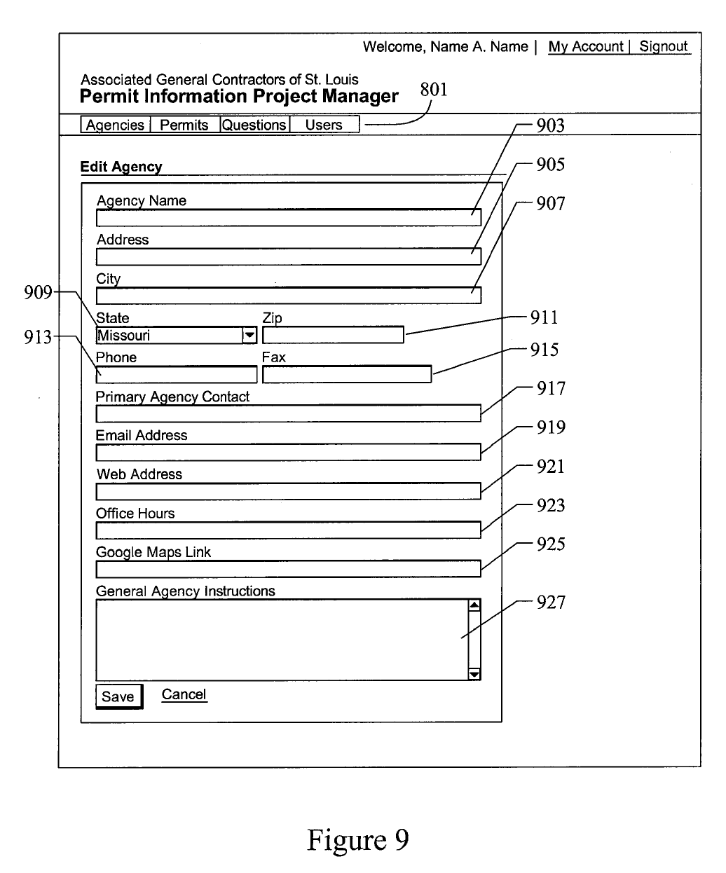

FIG. 8 depicts an exemplary admin page for display on a user computer which shows an exemplary list 805 of permitting agencies 805 which may represent all of the agencies for which data is stored in the system. An administrative navigation bar 801 is included on this page, which allows the user to navigate to admin pages for editing content relating to permitting agencies, permits, questions (e.g., the prompts displayed by the website), and website users. After logging in and selecting the “Agencies” button from navigation bar 801, an admin is able to modify the list 805 of permitting agencies and the data associated with each agency. For example, an admin may add a new agency by selecting the “New Agency” button 803. An admin may select an existing agency for possible editing by checking the box next to its name (e.g. box 807). The admin can then choose an operation from drop-down menu 809 and perform the operation on the selected agency using the “submit” button 811. For example, the admin may choose to edit an agency by selecting its box and choosing “edit” from drop-down menu 809 and then selecting submit button 811. The admin may also choose to delete an agency by selecting “delete” from drop-down menu 809 and selecting submit button 811, which will delete the agency from the system database. An admin may also request to edit the information associated with an existing agency by clicking the agency name. When creating a new agency, the admin will be presented with blank forms requesting agency information, such as the exemplary page shown in FIG. 9.

FIG. 9 depicts an exemplary page for soliciting information about an agency, including agency name (field 903), address (field 905), city name (field 907), state (field 909), zip (field 911), phone (field 913), fax (field 915), primary agency contact (field 917), email address (field 919), web address (field 921), office hours (field 923), a maps link (e.g., for “Google Maps”)(field 925), and general agency instructions (field 927). The user input in these fields can be used to populate the data structure (e.g., table 1510). When accessing a saved agency, the user may be presented with previously-entered data, and given the opportunity to make changes. This page may also include a field through which the user can define the permitting agency's jurisdictional boundaries, preferably by identifying the shapefile that is to be associated with the permitting agency. It should be understood that additional user entry fields may optionally be included on the page of FIG. 9.

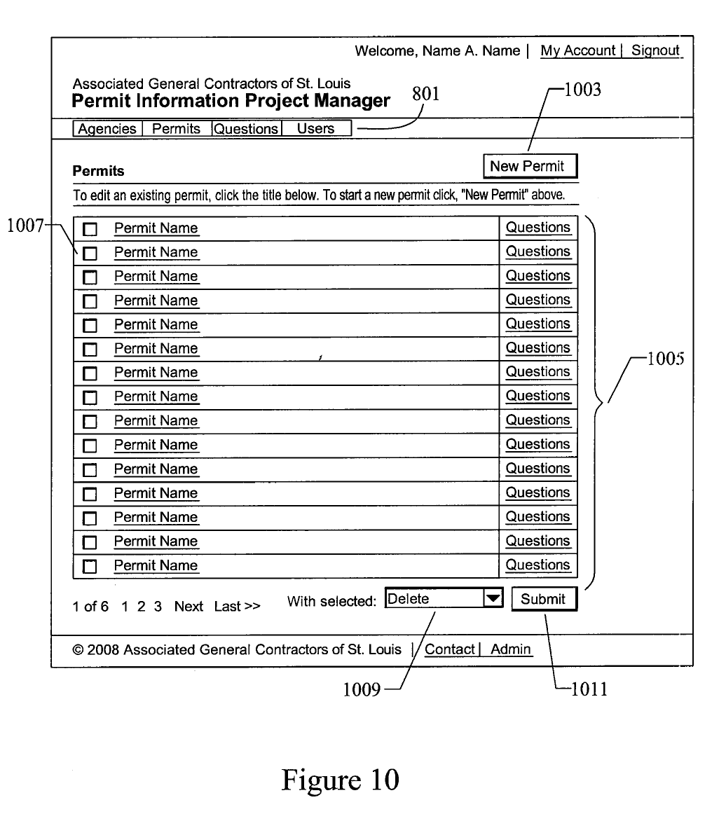

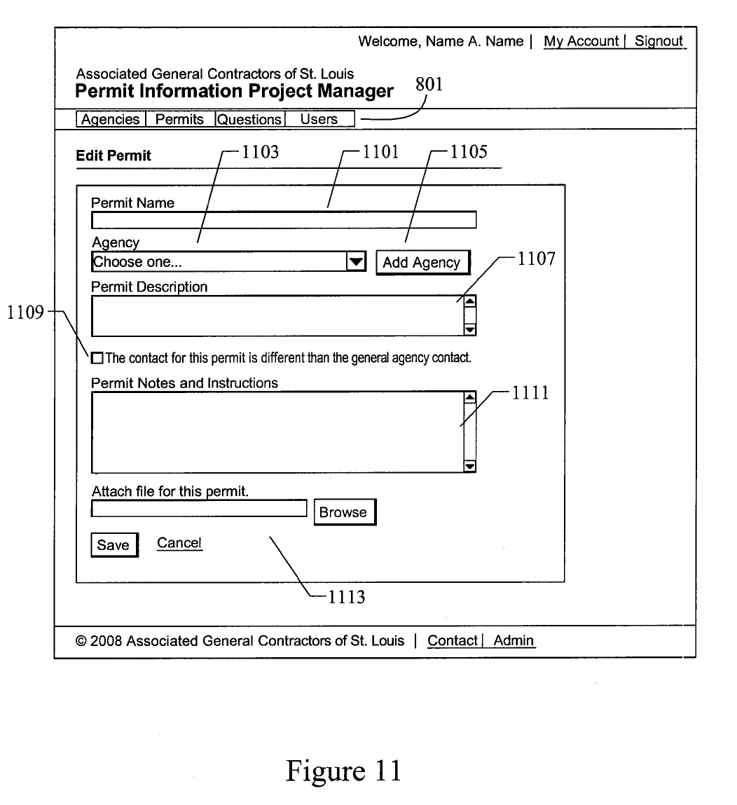

Upon selecting the “Permits” button from navigation bar 801, the page of FIG. 10 can be presented to the admin user. FIG. 10 shows an exemplary list 1005 of permits which may represent all of the permits for which data is stored in the system. After logging in, an admin is able to modify the list 1005 and the data associated with each permit. For example, an admin may add a new permit by selecting the “New Permit” button 1003. An admin may select an existing permit by checking the box next to its name (e.g. box 1007). The admin can then choose an operation from drop-down menu 1009 and perform the operation on the selected permit using the “submit” button 1011. For example, the admin may choose to edit a permit by selecting its box and choosing “edit” from drop-down menu 1009 and then selecting submit button 1011. The admin may also choose to delete a permit by selecting “delete” from drop-down menu 1009 and selecting submit button 1011, which will delete the permit from the system database. An admin may also request to edit the information associated with an existing permit by clicking the permit name. When creating a new permit, the admin will be presented with blank forms requesting permit information, such as the exemplary page shown in FIG. 11. An admin may also associate prompts with each permit by selecting the corresponding “Questions” link for that permit. FIGS. 12(a)-(c) depicts exemplary pages for assigning prompts to a permit.

FIG. 11 depicts an exemplary page for soliciting information about a permit, including permit name (field 1101), the permitting agency for that permit (drop down menu 1103 and button 1105), permit description (field 1107), permit notes and instructions (field 1111), a check box 1109 to indicate whether the contact for the permit is different than the general agency contact, and a field 1113 to specify a file to be attached for the permit. Such a file can be any document (or compressed archive of documents, e.g., zip format) that are relevant to the permit in some manner. As example, the files may include permit application forms, permit application instruction forms, and sample permits that are made available by the relevant permitting agencies. Then, in the website's output report, users can be provided with a link to these files to further help inform the user as to what needs to be done to obtain the applicable permit(s). When accessing a saved permit, the admin may be presented with previously entered data, and given the opportunity to make changes.

FIG. 12(a) illustrates an exemplary page for assigning prompts to a permit, reached following user selection of the “questions” link associated with a permit on list 1005 of FIG. 10. Text 1201 in the web page displays the name of the active permit. Next, using drop-down menu 1203, the admin chooses a prompt from the system database. For example the drop-down menu 1203 may be populated by data from prompt information table 1502 shown in FIG. 15(a). The selected prompt is now associated with the active permit, and the data structure is updated accordingly.

FIG. 12(b) depicts an exemplary web page for defining the effect of prompt response options. To populate the page of FIG. 12(b), the system queries the data structure to retrieve the prompt response options for the prompt selected in field 1203. In this exemplary embodiment, each possible response to the prompt identified in field 1207 (see the rows in column 1213) is associated with 3 radio buttons in columns 1207, 1209, and 1211. The administrator selects an effect for each response option. For example, if the admin wants to make a “Yes” answer to “Question Name 1” have the effect of confirming that the active permit is applicable, then the admin would check the “Include” radio button in the “Yes” row. Likewise, if the admin wants a “No” response from the user to have the effect of confirming that the active permit is inapplicable, then the admin would check the “Eliminate” radio button in the “No” row. Alternatively, if the admin wants a “No” answer to have no impact on the applicability of this permit, then the admin can select “No Change” in the “No” row. The “No Change” status can also be used where a permits applicability depends upon a combination of prompt responses. Upon selecting the desired effects for prompt responses via the page of FIG. 12(b), the admin user can select the “Save” button to thereby update the data structure accordingly. When finished, the admin can choose to add another prompt (e.g. another question) by selecting the “Add Another Question” link 1205.

FIG. 12(c) shows that the admin has assigned two prompts to the active permit. The admin may remove one of the prompts by selecting the “Delete question” link 1213. This will cause the corresponding prompt to be dis-associated from the active permit. The confirm/eliminate/no change user input section will work as described in connection with FIG. 12(b).

Based on the admin user's entries on the pages in FIGS. 12(b) and (c), the system updates that entries in columns 1529 and 1531 for that permit as appropriate.

It should be noted that ideally the prompts are drafted so as to invoke a response that in an of itself confirms a permit. However, whether this is possible will depend upon the complexity of the permit applicability requirements of the relevant permitting agencies. For instance, if a flagpole permit is required in City X for flagpoles that are (1) 50′ tall or greater, or (2) made of wood regardless of size, then one could draft a prompt to invoke a response that will immediately allow for permit confirmation. Thus, the prompt “Does your project include a flagpole over 50′ tall or a flagpole constructed of wood regardless of size?” would allow a “Yes” answer to confirm the flagpole permit as applicable and a “No” answer to confirm the flagpole permit as inapplicable. However, this permit applicability requirement could also be broken into multiple prompts, e.g., two prompts with the first prompt being “Does your project include a flagpole over 50″ tall?” (wherein a “Yes” answer will confirm the flagpole permit as applicable and a “No” answer results in a “No Change”, and the second prompt being “Is the flagpole to be made of wood?” (wherein a “Yes” answer will confirm the applicability of the flagpole permit and a “No” answer can be marked as either confirming the permit's inapplicability or a “no change”, depending on the processing logic of the software). If there is a potential that the software logic will select prompts out of sequence, then the “no change” status can be marked and the software logic can query the exclude conditions in column 1531 of table 1506 based on the session data to ultimately confirm the flagpole permit as inapplicable if the user responds with a “No” to both prompts.

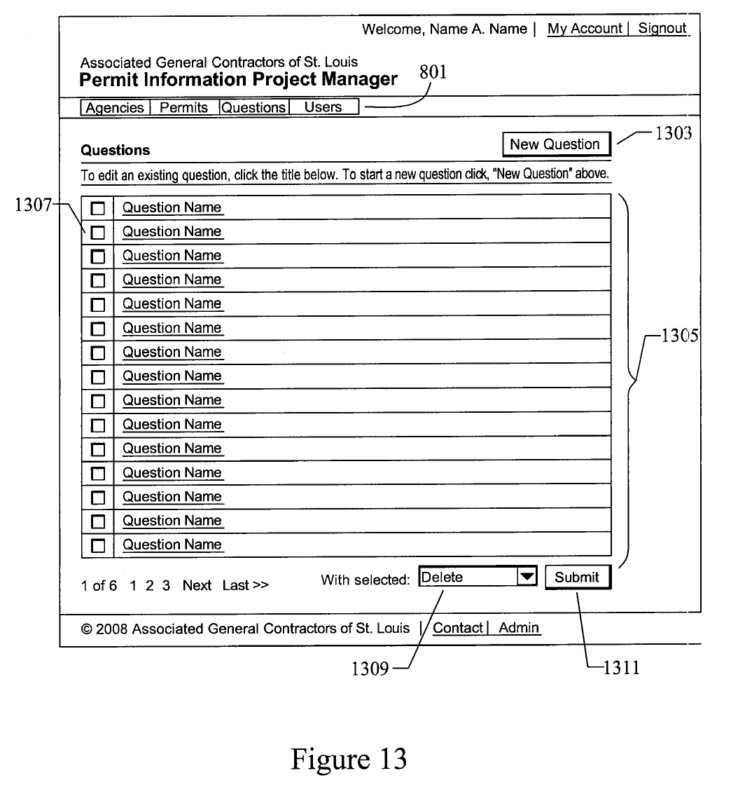

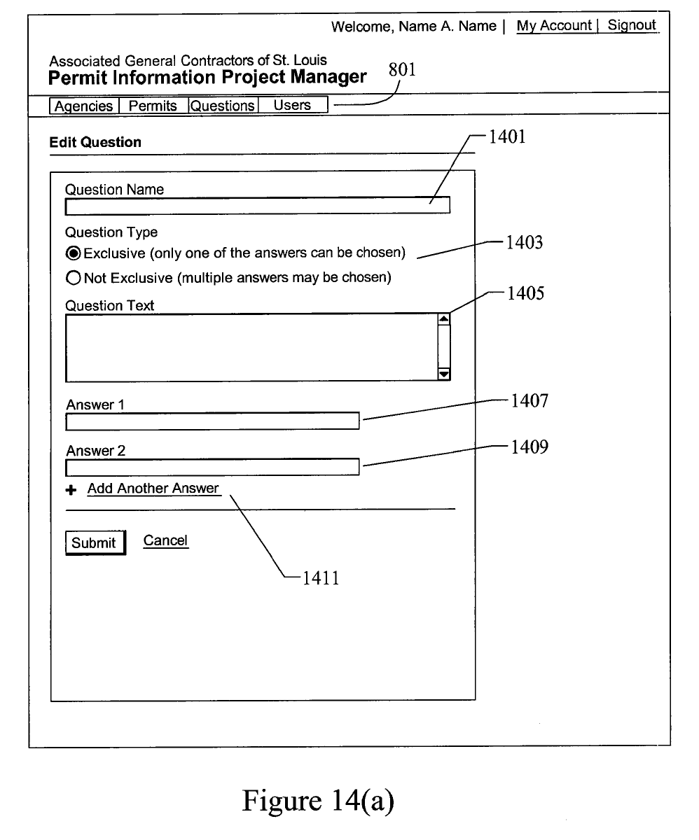

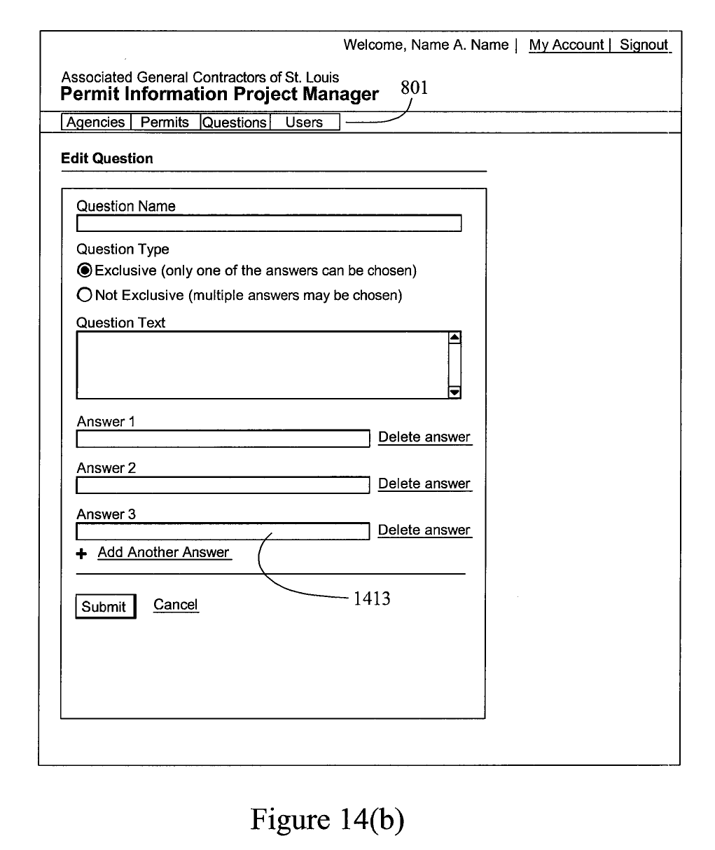

FIG. 13 illustrates an exemplary page for adding prompts to the data structure, reached following user selection of the “Questions” button within navigation bar 801. FIG. 13 shows an exemplary list 1305 of prompts which may represent all of the prompts for which data is stored in the system. After logging in, an admin is able to modify the list 1305 and the data associated with each prompt. For example, an admin may add a new prompt by selecting the new question button 1303. An admin may select an existing prompt by checking the box next to its name (e.g. box 1307). The admin can then choose an operation from drop-down menu 1309 and perform the operation on the selected prompt using the submit button 1311. For example, the admin may choose to edit a prompt by selecting its box and choosing “edit” from drop-down menu 1309 and then selecting submit button 1311. The admin may also choose to delete a prompt by selecting “delete” from drop-down menu 1309 and selecting submit button 1311, which will delete the prompt from the system database. An admin may also request to edit the information associated with an existing prompt by clicking the prompt name. When creating a new prompt, the admin will be presented with blank forms requesting prompt information, such as the exemplary page shown in FIG. 14(a).

FIG. 14(a) depicts an exemplary page for soliciting information about a prompt, including question name (field 1401), a question type (field 1403), a question text (field 1405), and fields 1407, 1409, . . . for defining the range of response options for the prompt. To add additional response option fields, the admin user can select the “Add Another Answer” link 1411 (such as when a multiple choice question may have numerous potential answers). FIG. 14(b) depicts an example where the “Add Another Answer” link 1411 has been selected to add another answer field 1413 to the page. Upon selection of the “Submit” button, the website's data structure is updated to add the defined prompt to table 1502. When accessing a saved prompt, the user may be presented with previously-entered data, and given the opportunity to make changes.

Preferably, via the various administrator-only pages described in connection with FIGS. 8-14(b), an administrator is provided with the ability to control the content of the data structure as needed to accommodate the permitting requirements of relevant permitting agencies over an area such a large metropolitan area. It should be understood that the actual formulation of the text for the prompts and prompt responses can be undertaken by a person having ordinary skill in the art upon review of the teachings herein in conjunction with consultation and research with respect to the publicly available permitting requirements of the permitting agencies in the geographical area covered by the website. Similarly, the associations between permits, permitting agencies, prompts, and prompt responses can be made by such an ordinarily-skilled person upon review of the teachings herein and consultation/research of the relevant permit applicability requirements. For example, a person who researches the permitting requirements in the city of Overland, Mo. may discover that a Street Closure Permit is needed in Overland for a new construction commercial building in Overland that is located on a lot size of less than an acre if the project will require the blocking of any primary or secondary roads. Thus, the prompt of “Will your project require blocking of any primary or secondary roads” will produce a prompt response that is salient as to whether the Street Closure Permit is needed. An administrator can then readily access the administrative features of the website described above to enter such a prompt into the data structure and associate its response options with the permit's applicability rules.

While the present invention has been described above in relation to its preferred embodiment, various modifications may be made thereto that still fall within the invention's scope, as would be recognized by those of ordinary skill in the art. Such modifications to the invention will be recognizable upon review of the teachings herein. For example, while the preferred embodiment discloses the use of a website to provide the users with the necessary interface for entering construction project data and learning which permits are applicable to the defined construction, it should be noted that the software logic could be resident on a stand-alone client which accesses a remote database that hosts the data structure, if desired by a practitioner. As such, the full scope of the present invention is to be defined solely by the appended claims and their legal equivalents.

What is claimed is:

1. An apparatus for determining which of a plurality of permits are applicable to a construction project, the apparatus comprising:
a processor for communication over a network with a user computer; and
a memory in communication with the processor, the memory comprising a data structure, the data structure comprising data corresponding to a plurality of permits and data corresponding to a plurality of applicability requirements for the permits;
wherein the processor is configured to execute a software application, the software application being configured to interact with a user of the user computer through a plurality of graphical user interface (GUI) pages, the GUI pages being configured to (1) prompt the user for information about a construction project, and (2) accept information about the construction project from the user computer to thereby define the construction project, and wherein the software application is further configured to process the accepted construction project information against the data structure to determine all of the permits which are applicable to the defined construction project.

2. The apparatus of claim 1 wherein the processor comprises a server configured to host a website, the website comprising the plurality of GUI pages.

3. The apparatus of claim 2 wherein the memory comprises a database.

4. The apparatus of claim 3 wherein the software application is further configured to iteratively interact with the user computer through the plurality of the GUI pages to iteratively collect information about the construction project and resolve which of the permits are applicable to the defined construction project.

5. The apparatus of claim 4 wherein the data structure comprises a plurality of data objects which are representative of the permits, a plurality of data objects which are representative of the prompts for information about the construction project, a plurality of data objects which are representative of potential prompt responses for the prompts, and a plurality of data objects which associate the prompt responses with the permits such that the software application can query the data structure based on the accepted construction project information to assess which permits can be confirmed as applicable or inapplicable to the defined construction project.

6. The apparatus of claim 5 wherein the software application is further configured with prompt selection logic for selecting a prompt from the data structure for presentation to the user based on which prompt has a greatest weight with respect to resolving which permits may be applicable or inapplicable to the defined construction project.

7. The apparatus of claim 4 wherein the software application is further configured to (1) initially prompt the user for a location for the construction project through one of the GUI pages, (2) accept input from the user through one of the GUI pages to define the location for the construction project, and (3) provide a GUI page for display on the user computer which displays the defined location on a map and prompts the user for a confirmation that the displayed location for the construction project is correct.

8. The apparatus of claim 4 wherein the software application is further configured to include a summary section on a plurality of the GUI pages which are configured to interact with the user computer to collect information about the construction project, wherein the summary section is configured to display a list of permits which are potentially applicable to the as defined construction project.

9. The apparatus of claim 4 wherein the software application is further configured to provide a GUI page for display on the user computer which displays a report, the report identifying all permits which are applicable to the defined construction project.

10. The apparatus of claim 9 wherein the report further identifies a permitting agency for each of the applicable permits.

11. A method for determining which of a plurality of permits are applicable to a construction project, the method comprising:
interacting with a user of a user computer through a plurality of graphical user interface (GUI) pages, wherein the interacting step comprises (1) prompting the user for information about a construction project, and (2) accepting information about the construction project from the user computer to thereby define the construction project; and
processing the accepted construction project information against a data structure to determine all of the permits which are applicable to the defined construction project;
wherein the data structure comprises data corresponding to the plurality of permits and data corresponding to a plurality of applicability requirements for the permits;
wherein the interacting and processing step are performed by at least one processor; and
wherein the data structure is resident on a computer memory in communication with the at least one processor.

12. The method of claim 11 wherein the processor comprises a server configured to host a website, the website comprising the plurality of GUI pages, and wherein the interacting step comprises interacting with the user computer through the website.

13. The method of claim 12 wherein the computer memory comprises a database.

14. The method of claim 13 wherein the interacting step further comprises iteratively interacting with the user computer through the plurality of the GUI pages to iteratively collect information about the construction project and resolve which of the permits are applicable to the defined construction project.

15. The method of claim 14 wherein the data structure comprises a plurality of data objects which are representative of the permits, a plurality of data objects which are representative of the prompts for information about the construction project, a plurality of data objects which are representative of potential prompt responses for the prompts, and a plurality of data objects which associate the prompt responses with the permits such that the processing step queries the data structure based on the accepted construction project information to assess which permits can be confirmed as applicable or inapplicable to the defined construction project.

16. The method of claim 15 wherein the processing step comprises selecting a prompt from the data structure for presentation to the user based on which prompt has a greatest weight with respect to resolving which permits may be applicable or inapplicable to the defined construction project.

17. The method of claim 14 wherein the interacting step further comprises (1) initially prompting the user for a location for the construction project through one of the GUI pages, (2) accepting input from the user through one of the GUI pages to define the location for the construction project, and (3) providing a GUI page for display on the user computer which displays the defined location on a map and prompts the user for a confirmation that the displayed location for the construction project is correct.

18. The method of claim 14 wherein the interacting step further comprises including a summary section on a plurality of the GUI pages which are configured to interact with the user computer to collect information about the construction project, wherein the summary section is configured to display a list of permits which are potentially applicable to the as defined construction project.

19. The method of claim 14 wherein the interacting step further comprises providing a GUI page for display on the user computer which displays a report, the report identifying all permits which are applicable to the defined construction project.

20. The method of claim 19 wherein the report further identifies a permitting agency for each of the applicable permits.

21. A computer-readable medium comprising:
a data structure resident on a computer-readable storage medium, the data structure comprising data corresponding to a plurality of permits and data corresponding to a plurality of applicability requirements for the permits, the permits being potentially applicable to a construction project; and
software code resident on a computer-readable storage medium, the software code configured to interact with a user of a user computer over a network through a plurality of graphical user interface (GUI) pages, the GUI pages being configured to (1) prompt the user for information about the construction project, and (2) accept information about the construction project from the user computer to thereby define the construction project, and wherein the code segment is further configured to process the accepted construction project information against the data structure to determine all of the permits which are applicable to the defined construction project.

22. An apparatus for determining which of a plurality of permits are applicable to a construction project, the apparatus comprising:
a processor for communication over a network with a user computer, the processor configured to execute a software application, the software application being configured to interact with a user of the user computer through a plurality of graphical user interface (GUI) pages, the GUI pages being configured to (1) prompt the user for information about a construction project, and (2) accept information about the construction project from the user computer to thereby define the construction project; and
a memory in communication with the processor, the memory comprising a data structure, the data structure comprising (1) a plurality of data objects which are representative of the permits, (2) a plurality of data objects which are representative of prompts for information about the construction project, (3) a plurality of data objects which are representative of potential prompt responses for the prompts, and (4) a plurality of data objects which associate the prompt responses with the permits such that the software application can query the data structure based on the accepted construction project information to assess which permits can be confirmed as applicable or inapplicable to the defined construction project;
wherein the software application is further configured to process the accepted construction project information against the data structure to determine which of the permits are applicable to the defined construction project.

23. The apparatus of claim 22 wherein the processor comprises a server configured to host a website, the website comprising the plurality of GUI pages.

24. The apparatus of claim 23 wherein the memory comprises a database.

25. The apparatus of claim 24 wherein the software application is further configured to iteratively interact with the user computer through the plurality of the GUI pages to iteratively collect information about the construction project and resolve which of the permits are applicable to the defined construction project.

26. The apparatus of claim 25 wherein the software application is further configured with prompt selection logic for selecting a prompt from the data structure for presentation to the user based on which prompt has a greatest weight with respect to resolving which permits may be applicable or inapplicable to the defined construction project.

27. The apparatus of claim 25 wherein the software application is further configured to include a summary section on a plurality of the GUI pages which are configured to interact with the user computer to collect information about the construction project, wherein the summary section is configured to display a list of permits which are potentially applicable to the as defined construction project.

28. The apparatus of claim 25 wherein the software application is further configured to provide a GUI page for display on the user computer which displays a report, the report identifying the permits which are applicable to the defined construction project.

29. A method for determining which of a plurality of permits are applicable to a construction project, the method comprising:
interacting with a user of the user computer through a plurality of graphical user interface (GUI) pages, wherein the interacting step comprises (1) prompting the user for information about a construction project, and (2) accepting information about the construction project from the user computer to thereby define the construction project; and
processing the accepted construction project information against a data structure to determine which of the permits are applicable to the defined construction project;
wherein the data structure comprises (1) a plurality of data objects which are representative of the permits, (2) a plurality of data objects which are representative of prompts for information about the construction project, (3) a plurality of data objects which are representative of potential prompt responses for the prompts, and (4) a plurality of data objects which associate the prompt responses with the permits such that the processing step can query the data structure based on the accepted construction project information to assess which permits can be confirmed as applicable or inapplicable to the defined construction project;
wherein the interacting and processing step are performed by at least one processor; and
wherein the data structure is resident on a computer memory in communication with the at least one processor.

30. The method of claim 29 wherein the processor comprises a server configured to host a website, the website comprising the plurality of GUI pages, and wherein the interacting step comprises interacting with the user computer through the website.

31. The method of claim 30 wherein the computer memory comprises a database.

32. The method of claim 31 wherein the interacting step further comprises iteratively interacting with the user computer through the plurality of the GUI pages to iteratively collect information about the construction project and resolve which of the permits are applicable to the defined construction project.

33. The method of claim 32 wherein the processing step comprises selecting a prompt from the data structure for presentation to the user based on which prompt has a greatest weight with respect to resolving which permits may be applicable or inapplicable to the defined construction project.

34. The method of claim 32 wherein the interacting step further comprises including a summary section on a plurality of the GUI pages which are configured to interact with the user computer to collect information about the construction project, wherein the summary section is configured to display a list of permits which are potentially applicable to the as defined construction project.

35. The method of claim 32 wherein the interacting step further comprises providing a GUI page for display on the user computer which displays a report, the report identifying all permits which are applicable to the defined construction project.

36. A computer-readable medium comprising:
a data structure resident on a computer-readable storage medium, the data structure comprising (1) a plurality of data objects which are representative of a plurality of permits, the permits being potentially applicable to a construction project, (2) a plurality of data objects which are representative of prompts for information about the construction project, (3) a plurality of data objects which are representative of potential prompt responses for the prompts, and (4) a plurality of data objects which associate the prompt responses with the permits such that a software application can query the data structure based on a plurality of user-specified prompt responses which define the construction project to assess which permits can be confirmed as applicable or inapplicable to the defined construction project.

37. An apparatus for administering a data structure, the apparatus comprising:
a processor for communication over a network with a user computer; and
a memory in communication with the processor, the memory comprising the data structure, the data structure comprising (1) a plurality of data objects which are representative of a plurality of permits, the permits being potentially applicable to a construction project, (2) a plurality of data objects which are representative of prompts for information about the construction project, (3) a plurality of data objects which are representative of potential prompt responses for the prompts, and (4) a plurality of data objects which associate the prompt responses with the permits such that a software application can query the data structure based on a plurality of user-specified prompt responses which define the construction project to assess which permits can be confirmed as applicable or inapplicable to the defined construction project;
wherein the processor is configured to interact with a user of the user computer through a plurality of graphical user interface (GUI) pages to define a plurality of the data objects in the data structure in response to user input.

38. The apparatus of claim 37 wherein the processor comprises a server configured to host a website, the website comprising the plurality of GUI pages.

39. The apparatus of claim 38 wherein the memory comprises a database.

40. The apparatus of claim 37 wherein the processor is further configured to interact with a user of the user computer through at least one of the GUI pages to define a plurality of data objects in the data structure corresponding to text for the prompts.

41. The apparatus of claim 37 wherein the processor is further configured to interact with a user of the user computer through at least one of the GUI pages to define a plurality of data objects in the data structure corresponding to text for the prompt responses.

42. The apparatus of claim 41 wherein the processor is further configured to interact with a user of the user computer through at least one of the GUI pages to define a type for each of the prompts, the type defining whether the prompt responses for each prompt will be exclusive or nonexclusive prompt responses.

43. The apparatus of claim 37 wherein the processor is further configured to interact with a user of the user computer through at least one of the GUI pages to define a plurality of data objects in the data structure that associate the prompt responses with the permits such that the software application can query the data structure based on the plurality of user-specified prompt responses which define the construction project to assess which permits can be confirmed as applicable or inapplicable to the defined construction project.

44. A method for administering a data structure, the method comprising:
storing a data structure in a computer memory, the data structure comprising (1) a plurality of data objects which are representative of a plurality of permits, the permits being potentially applicable to a construction project, (2) a plurality of data objects which are representative of prompts for information about the construction project, (3) a plurality of data objects which are representative of potential prompt responses for the prompts, and (4) a plurality of data objects which associate the prompt responses with the permits such that a software application can query the data structure based on a plurality of user-specified prompt responses which define the construction project to assess which permits can be confirmed as applicable or inapplicable to the defined construction project; and
interacting with a user of a user computer through a plurality of graphical user interface (GUI) pages to define a plurality of the data objects in the data structure in response to user input, wherein the interacting step is performed by a processor in communication with the computer memory.

45. The method of claim 44 wherein the processor comprises a server configured to host a website, the website comprising the plurality of GUI pages, and wherein the interacting step comprises interacting with the user computer through the website.

46. The method of claim 45 wherein the computer memory comprises a database.

47. The method of claim 44 wherein the interacting step further comprises interacting with a user of the user computer through at least one of the GUI pages to define a plurality of data objects in the data structure corresponding to text for the prompts.

48. The method of claim 44 wherein the interacting step further comprises interacting with a user of the user computer through at least one of the GUI pages to define a plurality of data objects in the data structure corresponding to text for the prompt responses.

49. The method of claim 48 wherein the interacting step further comprises interacting with a user of the user computer through at least one of the GUI pages to define a type for each of the prompts, the type defining whether the prompt responses for each prompt will be exclusive or nonexclusive prompt responses.

50. The method of claim 44 wherein the interacting step further comprises interacting with a user of the user computer through at least one of the GUI pages to define a plurality of data objects in the data structure that associate the prompt responses with the permits such that the software application can query the data structure based on the plurality of user-specified prompt responses which define the construction project to assess which permits can be confirmed as applicable or inapplicable to the defined construction project.

51. A computer-readable medium comprising:
a data structure resident on a computer-readable storage medium, the data structure comprising (1) a plurality of data objects which are representative of a plurality of permits, the permits being potentially applicable to a construction project, (2) a plurality of data objects which are representative of prompts for information about the construction project, (3) a plurality of data objects which are representative of potential prompt responses for the prompts, and (4) a plurality of data objects which associate the prompt responses with the permits such that a software application can query the data structure based on a plurality of user-specified prompt responses which define the construction project to assess which permits can be confirmed as applicable or inapplicable to the defined construction project; and
software code resident on a computer-readable storage medium, the software code configured to interact with a user of a user computer through a plurality of graphical user interface (GUI) pages to define a plurality of the data objects in the data structure in response to user input.

52. A method comprising:
performing an interactive question-giving and answer-receiving session with a user computer over a network to determine which of a plurality of permits are applicable to a construction project, the construction project defined by a plurality of answers received from a user of the user computer in response to a plurality of questions presented to the user during the session, wherein the performing step includes selecting each question for presentation to the user during the session from a plurality of the questions based on which question has a greatest relevance to the most permits relative to the other questions, and wherein the performing step and the selecting step are performed by a processor.
